(19) United States
(12) Patent Application Publication
(10) Pub. No.: US 2004/0046705 A1
(43) Pub. Date: Mar. 11, 2004

(54) Liquid crystal display apparatus

(75) Inventors: Naoki Masazumi, Kobe-Shi (JP); Shuji Yoneda, Osaka-Shi (JP); Eiji Yamakawa, Sanda-Shi (JP); Katsuhiko Asai, Takatsuki-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/324,272

(22) Filed: Dec. 19, 2002

(30) Foreign Application Priority Data
Sep. 20, 2002 (JP) 2002-276409
Sep. 20, 2002 (JP) 2002-276410
Sep. 20, 2002 (JP) 2002-276411

(51) Int. Cl. G09G 5/00

(52) U.S. Cl. 345/1.1

(57) ABSTRACT

A liquid crystal display apparatus which has a first display panel and a second display panel which use liquid crystal as display media, a driving circuit which scans matrix-arranged pixels of each of the panels line by line, and a controller which controls the driving circuit. The controller changes the rate of the length of a delay step Td which is inserted between scanning lines to be sequentially scanned to the length of a scanning time Tss in accordance with circumstantial temperature. Also, the way of changing the rate of Td to Tss in a single writing mode and the way of changing the rate Td to Tss in a double writing mode are different.

This application is based on Japanese Patent Application Nos. 2002-276409, 2002-276410 and 2002-276411, the content of which are herein incorporated by reference.

### BACKGROUND OF THE INVENTION

1. Field of the Invention

The present invention relates to a liquid crystal display apparatus, and more particularly to a liquid crystal display apparatus which comprises two display panels which use liquid crystal displays or to a liquid crystal display apparatus which comprises one or more display panels which use liquid crystal displays.

2. Description of Related Art

In recent years, as media for reproducing digital information as visual information, reflective type liquid crystal displays which use liquid crystal which exhibits a cholesteric phase at room temperature (typically, chiral nematic liquid crystal) have been studied and developed into various kinds because such liquid crystal displays have the advantage of continuing displaying images thereon with no voltages applied thereon, thereby consuming little electric power and the advantage of being produced at low cost.

In order to write an image on such a liquid crystal display panel, a method which comprises a reset step of resetting the liquid crystal to a homeotropic state, a selection step of selecting a desired final state of the liquid crystal, an evolution step of causing the liquid crystal to evolve to the selected state has been suggested.

Incidentally, the response speed of chiral nematic liquid crystal to a voltage applied thereto increases as the circumstantial temperature is rising. Accordingly, as the circumstantial temperature is rising, the frequency of driving pulses must be heightened by altering a basic clock. There is, however, a problem that as the frequency of driving pulses becomes higher, the consumption of electric power becomes larger.

In a liquid crystal display apparatus with two display panels, such as an electronic book, when the two screens are to be renewed simultaneously, the peak current may be too high, and measures to avoid this trouble are necessary.

Further, two driving circuits which drive these two screens respectively are necessary. Also, it is necessary to avoid a difference in quality between displays on the two panels which may be caused by differences in characteristics (in thickness of the liquid crystal layer, in composition, etc.) between the display panels, changes in circumstantial temperature, etc. so that homogeneity between displays on the two display panels can be guaranteed. It is also important to structure the driving circuits at low cost.

Additionally, display panels of this kind have the following problem: if driving pulses to renew the screens are in a fixed polarity at all times, the liquid crystal will degrade, and display performance will be lowered. In an electronic book type liquid crystal display apparatus with two display panels, it is significant how to combine polarities of driving pulses for writing on the two panels simultaneously or separately and for writing on the panels partly or entirely.

### SUMMARY OF THE INVENTION

An object of the present invention is to provide a liquid crystal display apparatus which inhibits an increase in power consumption at a time of writing on two display panels simultaneously and an increase in power consumption with a rise in circumstantial temperature to permit usage of a battery with a small power supply.

Another object of the present invention is to provide a liquid crystal display apparatus which can make displays of the same quality on two display panels, which can comply with difference in characteristics between the panels and changes in circumstantial temperature and which has an inexpensive driving circuit.

Further, another object of the present invention is to provide a liquid crystal display apparatus which, in carrying out writing on one or more display panels, can prevent liquid crystal of the display panels from being degraded by influence of driving pulses thereto.

In order to attain the objects above, a liquid crystal display apparatus according to a first aspect of the present invention comprises: a first display panel and a second display panel which use liquid crystal as display media; a driving circuit which drives the first display panel and the second display panel by a cycle of driving pulses; a controller for controlling the driving circuit; and a temperature sensor for detecting circumstantial temperatures of the first display panel and the second display panel. In the apparatus, each of the first and second display panels has a screen composed of a plurality of pixels arranged in a matrix, and the driving circuit scans the pixels of each of the first and second display panels in such a way that pixels on one line are scanned at a time. The controller is selectable between a single writing mode where the driving circuit drives either one of the first and second display panels and a double writing mode where the driving circuit drives both the first and second display panels simultaneously, and the controller changes at least one of the following conditions in accordance with circumstantial temperature: (a) a rate of a length of a delay step inserted between sequentially scanned scanning lines to a length of a scanning step; (b) a ratio of pulse widths of the driving pulses in a cycle; and (c) a length of the whole cycle of driving pulses with the ratio of pulse widths of the driving pulses in a cycle kept constant, and changes at least one of the conditions (a), (b) and (c) in a different way between the single writing mode and the double writing mode.

In the liquid crystal display apparatus according to the first aspect of the invention, at least one of the conditions (a), (b) and (c) is changed with changes in circumstantial temperature. Thereby, even when the circumstantial temperature rises, the frequency of driving pulses is inhibited from becoming high, and an increase in power consumption can be inhibited. Further, the way of changing at least one of the conditions (a), (b) and (c) in the single writing mode is different from the way of changing at least one of the conditions (a), (b) and (c) in the double writing mode. Thereby, trouble such as an excess increase in peak current in the double writing mode and excess narrowing of the pulse widths of driving pulses beyond the limit of the driving circuit can be prevented. Consequently, the display panels can be driven under appropriate conditions.

Especially adopting a delayed scanning method, in which a delay step is inserted between scanning lines to be scanned sequentially, is effective to lower the driving frequency. In this case, even when circumstantial temperature rises, the frequency of driving pulses can be inhibited from becoming too high, and an increase in power consumption can be prevented.

In the liquid crystal display apparatus according to the first aspect of the present invention, the controller may change at least one of the conditions (a), (b) and (c) in accordance with circumstantial temperature in the single writing mode and in the double writing mode in such a way that the lower limit of the writing time in the double writing mode is larger than twice the lower limit of the writing time in the single writing mode. With this arrangement, an excess increase in peak current in the double writing mode can be prevented more effectively.

Also, the controller may change the condition (b) and/or the condition (c) in accordance with circumstantial temperature in such a way that the pulse width of the selection pulse will not be smaller than a specified width. With this arrangement, the writing time is prevented from becoming too long, and lowering of the operability can be prevented.

In the liquid crystal display apparatus according to the first aspect of the present invention, the first and second display panels make displays by using selective reflection of a cholesteric liquid crystal phase. A duration in which the driving circuit applies driving pulses to the liquid crystal comprises a reset step of applying a reset pulse to reset the liquid crystal to a homeotropic state, a selection step of applying a selection pulse to select a desired final state of the liquid crystal and an evolution step of applying an evolution pulse to cause the liquid crystal to evolve to the desired state. The controller preferably carries out the following control: as long as circumstantial temperature changes within a first range, the controller changes the conditions (a) and (c) in accordance with the circumstantial temperature while keeping the condition (b) constant; as long as the circumstantial temperature changes within a second range which is different from the first range, the controller changes the conditions (a) and (c) in accordance with the circumstantial temperature while keeping the condition (b) constant by fixing a rate Tsp/Ts to a value which is different from that in the first temperature range, in which Tsp is a length of a selection pulse application step which is a step of applying a selection pulse to each pixel on a scanning line, and Ts is a length of the selection step between the end of application of the reset pulse and the start of application of the evolution pulse. The control of drives of the first and second display panels is easy. In this case, the controller, as long as the circumstantial temperature changes within a third range which is narrower than and included in the first range, preferably changes the condition (c) in accordance with the circumstantial temperature while keeping the conditions (a) and (b).

The controller changes the rate Tsp/Ts in accordance with the circumstantial temperature; preferably, the way of changing Tsp/Ts in the single writing mode is different from the way of changing Tsp/Ts in the double writing mode. Thereby, an excess increase in frequency of driving pulses and an excess increase in peak current can be prevented, and the display panels can be driven under appropriate conditions.

A liquid crystal display according to a second aspect of the present invention comprises: a first display panel and a second display panel which use liquid crystal as display media; and a driving circuit for driving the first and second display panels. In the apparatus, the driving circuit applies a cycle of driving pulses composed of a plural kinds of pulses to the liquid crystal of the first and second display panels. A voltage of at least one kind of pulse of the plural kinds is supplied to the first and second display panels respectively via mutually independent power source terminals, and voltages of the other kinds of pulses are supplied to the first and second display panels via common power source terminals.

In the liquid crystal display apparatus according to the second aspect of the present invention, a voltage of at least one kind of pulse of the plural kinds of driving pulses is supplied to the first and second display panels respectively via mutually independent power source terminals, and voltages of the other kinds of pulses are supplied to the first and second display panels via common power source terminals. Thereby, most part of the driving circuit can be used both for the first display panel and for the second display panel. Consequently, a difference in quality between displays on the two panels can be inhibited, and the driving circuit can be structured at low cost. Also, there may be a difference in display performance between the two panels due to differences in characteristics between the panels, changes in circumstantial temperature, etc.; however, since a voltage of at least one kind of pulse is supplied to the first and second display panels respectively via mutually independent power source terminals, it is possible to also supply pulses for correcting the difference via the separate power source terminals.

In the liquid crystal display apparatus according to the second aspect of the present invention, each of the first and second display panels has a liquid crystal layer between a plurality scanning electrodes and a plurality of signal electrodes. The scanning electrodes are connected to a scanning electrode driving IC, and the signal electrodes are connected to a signal electrode driving IC. A cycle of driving pulses composed of plural kinds of pulses are applied to each of the scanning electrodes from the scanning electrode driving IC. At this time, a voltage of at least one kind of pulse of the plural kinds is supplied to the first and second display panels respectively via mutually independent power source terminals, and voltages of the other kinds of pulses are supplied to the first and second display terminals via common power source terminals.

The scanning electrode driving IC further comprises a power switching circuit for switching power source terminals and a level shifter for carrying out voltage compensation at the time of switching voltages. The polarity of the driving pulses applied to the scanning electrodes may be inverted. In this case, an inexpensive IC can be used as the scanning electrode driving IC, and the cost can be reduced more. Moreover, by inverting the polarity of the driving pulses, degradation of the liquid crystal can be prevented.

Also, at least one of the first and second display panels may be a laminate type liquid crystal display panel which has a plurality of liquid crystal layers stacked one upon another. In this case, each of the liquid crystal layers is located between a plurality of scanning electrodes and a plurality of signal electrodes, and one scanning electrode driving IC may be used to drive all the liquid crystal layers of the laminate type liquid crystal display panel.

In the liquid crystal display apparatus according to the second aspect of the present invention, the first and second display panels may make displays by using selective reflection of a cholesteric liquid crystal phase, and the driving circuit may apply a reset pulse to reset the liquid crystal to a homeotropic state, a selection pulse to select a desired final state of the liquid crystal and an evolution pulse to cause the liquid crystal to evolve to the selected state.

In such a liquid crystal display, the voltage which is supplied to the first and second display panels respectively via mutually independent power source terminals is preferably for the selection pulse, and the voltages which are supplied to the first and second display panels via common power source terminals are preferably for the reset pulse and the evolution pulse. By applying the selection pulse to the first and second display panels respectively via mutually independent power source terminals, differences in quality between displays on the two panels which may be caused by differences in characteristics between the two panels and changes in circumstantial temperatures, etc. can be corrected.

A liquid crystal display apparatus according to a third aspect of the present invention comprises: a display section which comprises at least one liquid crystal panel which is capable of continuously displaying an image with application of no voltages thereto; a driving circuit for driving the display section; and a controller for controlling the driving circuit. In the apparatus, the controller sends the driving circuit selectively a command of writing on part of the display section and a command of writing on the entire display section, and in carrying out writing, the controller controls the driving circuit to carry out writing of one frame by using driving pulses of one polarity, to carry out writing of a next frame by using driving pulses of an opposite polarity and to select the polarity of driving pulses so that an area of the display section will not be subjected continuously to a specified number of or more times of writing in the same polarity.

In the liquid crystal display apparatus according to the third aspect of the present invention, the driving circuit is controlled to carry out writing of one frame by using driving pulses of one polarity and to carry out writing of a next frame by using driving pulses of an opposite polarity. Also, the controller selects the polarity of driving pulses so that an area of the display section will not be subjected to writing by using driving pulses of one polarity continuously more than a specified number of times, and thereby, the area is inhibited from being supplied with more than a specified number of cycles of driving pulses of the same polarity continuously. Consequently, degradation of the liquid crystal can be prevented.

In the liquid crystal display apparatus according to the third aspect of the present invention, the controller may sends the driving circuit selectively a command of writing on part of the liquid crystal panel and a command of writing on the entire liquid crystal panel, and in carrying out writing, the controller controls the driving circuit to carry out writing of one frame by using driving pulses of one polarity, to carry out writing of a next frame by using driving pulses of an opposite polarity and to select the polarity of driving pulses so that an area will not be subjected continuously to a specified number of or more times of writing in the same polarity.

Also, the display section may comprise a plurality of liquid crystal panels. In this case, the controller sends the driving circuit selectively a command of writing on a first number of liquid crystal panels and a command of writing on a second number of liquid crystal panels, in which the first number is smaller than the total number of liquid crystal panels and the second number is larger than the first number. In carrying out writing, the controller controls the driving circuit to carry out writing of one frame by using driving pulses of one polarity, to carry out writing of a next frame by using driving pulses of an opposite polarity and to select the polarity of driving pulses so that an area will not be subjected continuously to a specified number of or more times of writing in the same polarity.

The liquid crystal display apparatus according to the third aspect of the present invention further comprises a memory to be stored with the polarity of driving pulses, and the controller preferably determines the polarity of driving pulses with reference to data stored in the memory.

Further, preferably, the controller inhibits an area of the display section from being subjected to writing by using driving pulses of one polarity continuously twice or more. Also, in carrying out writing on part of the display section, the controller controls the driving circuit to carry out a plurality of times of writing while using driving pulses of one polarity and using driving pulses of an opposite polarity alternately.

In the liquid crystal display apparatus according to the third aspect of the present invention, each of the liquid crystal panels may have a liquid crystal layer between a plurality of scanning electrodes and a plurality of signal electrodes. Driving pulses of substantially one polarity may be applied to the scanning electrodes, and in synchronization with the driving pulses applied to each of the scanning electrodes, specified driving pulses may be applied to the signal electrodes.

### BRIEF DESCRIPTION OF THE DRAWINGS

This and other objects and features of the present invention will be apparent from the following description with reference to the accompanying drawings, in which:

FIG. 1 is a perspective view of a liquid crystal display apparatus which is an embodiment of the present invention;

FIG. 2 is a sectional view of an exemplary liquid crystal display provided in the liquid crystal display apparatus;

FIG. 3 is a block diagram which shows a control circuit of the liquid crystal display;

FIG. 4 is a block diagram which shows arrangement of ICs for driving a three-layered liquid crystal display;

FIG. 5 is a chart which shows basic driving pulses to drive the liquid crystal display;

FIG. 6 is a chart which shows driving waves applied on each pixel of the liquid crystal display for writing of a frame of an even number;

FIG. 7 is a chart which shows driving waves applied on each pixel of the liquid crystal display for writing of a frame of an add number;

FIG. 8 is a chart which shows the driving waves shown by FIGS. 6 and 7 in more detail, the driving waves are to cause the liquid crystal to come to a selective reflection state;

FIG. 9 is a chart which shows the driving waves shown by FIGS. 6 and 7 in more detail, the driving waves are to cause the liquid crystal to come to an intermediate state;

FIG. 10 is a chart which shows the driving waves shown by FIGS. 6 and 7 in more detail, the driving waves are to cause the liquid crystal to come to a light transmitting state;

FIG. 11 is a block diagram of a power supply section, showing a case of supplying driving pulses of the positive polarity;

FIG. 12 is a block diagram of the power supply section, showing a case of supplying driving pulses of the negative polarity;

FIGS. 13a through 13e are charts which show driving waves which are applied to scanning electrodes under various circumstantial temperatures;

FIG. 14 is a chart which shows driving waves in a driving example 1 adopting a delayed scanning mode;

FIG. 15 is a chart which shows driving waves in a driving example 2 adopting a delayed scanning mode;

FIG. 16 shows a graph which shows relationships between circumstantial temperature and writing time under different conditions in which the length of a delay step and the rate Tss/Ts are varied;

FIG. 17 is an illustration of writing on a screen in a double writing mode;

FIG. 18 is an illustration of writing on a screen in a single writing mode;

FIG. 19 is an illustration of writing on a screen in a partial writing mode;

FIG. 20 is a flowchart which shows a control procedure (main routine) of the liquid crystal display apparatus;

FIGS. 21, 22 and 23 are flowcharts which show a first example of a polarity determination process;

FIGS. 24, 25 and 26 are flowcharts which show a second example of the polarity determination process; and

FIGS. 27, 28, 29, 30 and 31 are flowcharts which shows a third example of the polarity determination process.

### DETAILED DESCRIPTION OF THE PREFERRED EMBODIMENTS

Embodiments of a liquid crystal display apparatus according to the present invention are described with reference to the accompanying drawings.

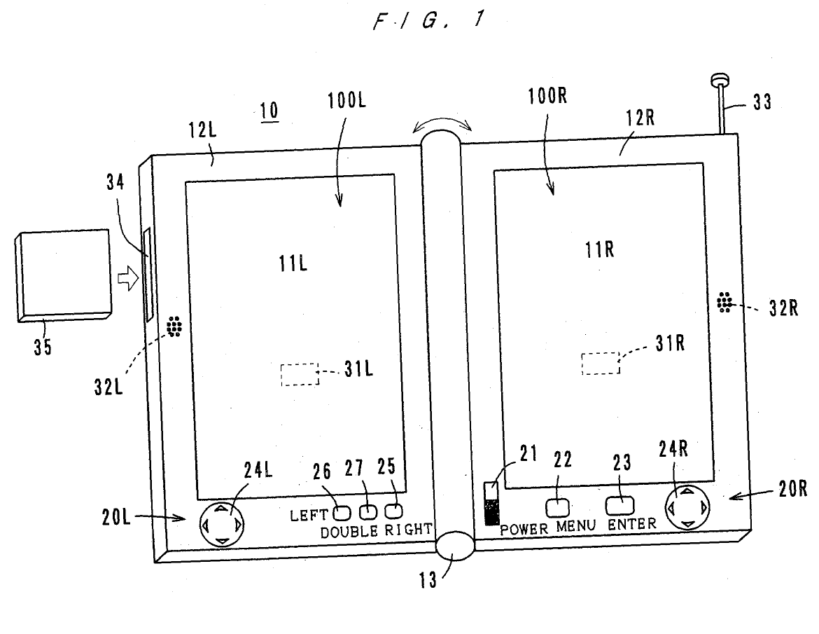

### General Structure of Liquid Crystal Display Apparatus; See FIG. 1

As an embodiment of a liquid crystal display apparatus according to the present invention, an electronic book type liquid crystal display apparatus 10 shown by FIG. 1 is described. This liquid crystal display apparatus 10 has two screens which can be made into a spread.

The liquid crystal display apparatus 10 comprises a liquid crystal display panel 11R which serves as a right page and a liquid crystal display panel 11L which serves as a left page. The panels 11R and 11L have liquid crystal displays 100R and 100L in respective frames 12R and 12L. The frames 12R and 12L are connected to each other by a hinge 13 and can be made into a closed state where the two screens are overlaid and into an open state where the two screens are spread side by side.

The lower parts of the frames 12R and 12L serve as operation panels 20R and 20L respectively. In the operations panels 12R and 12L, there are provided a power key 21 for turning on and off the main power, a menu key 22 for displaying a menu, an enter key 23 for entering a determined command, cursor keys 24R and 24L, a key 25 for selecting a mode of renewing only the right screen, a key 26 for selecting a mode of renewing only the left screen, and a key 27 for selecting a mode of renewing the both screens simultaneously.

In the frames 12R and 12L, respectively, there are also provided temperature sensors 31R and 31L for detecting the circumstantial temperatures of the liquid crystal displays 100R and 100L and speakers 32R and 32L. In the frame 12R, further, an antenna 33 for sending and receiving communication radio waves is provided. In the frame 12L, a slot 34 for permitting insertion of a storage medium 35. The storage medium 35 is stored with data to be displayed on the display panels 11R and 11L and may be a semiconductor memory, an optical disk, a removable hard disk or the like. Data to be displayed on the display panels 11R and 11L can be inputted in this liquid crystal display apparatus 10 also via the antenna 33. Further, a control section 50 (which will be described later) comprising a driving circuit for driving the liquid crystal displays 100R and 100L is provided in the frames 12R and 12L.

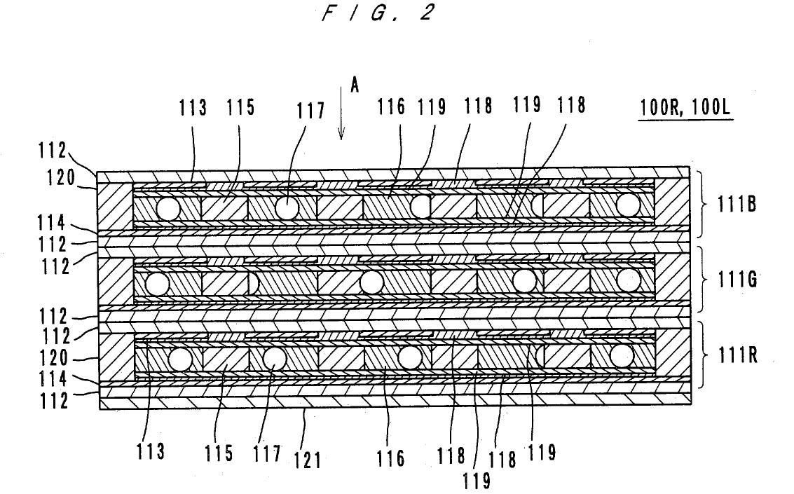

### Liquid Crystal Displays; See FIG. 2

Now, the liquid crystal displays 100R and 100L are described. Each of the liquid crystal displays 100R and 100L is of a structure shown by FIG. 2. Each of the liquid crystal displays 100R and 100L is a reflective type full-color liquid crystal display which has display layers 111R, 111G and 111B laminated one upon another, each display layer comprising liquid crystal which exhibits a cholesteric phase, and these displays 100R and 100L are driven by a simple matrix driving method.

Each of the liquid crystal displays 100R and 100L has, on a light absorbing layer 121, a red display layer 111R, a green display layer 111G and a blue display layer 111B which are stacked in this order. The red display layer 111R makes a display by switching the liquid crystal between a selective reflection state to selectively reflect light of red and a transparent state. The green display layer 111G makes a display by switching the liquid crystal between a selective reflection state to selectively reflect light of green and a transparent state. The blue display layer 111B makes a display by switching the liquid crystal between a selective reflection state to selectively reflect light of blue and a transparent state.

Each of the display layers 111R, 111G and 111B has liquid crystal 116 and spacers 117 between transparent substrates 112, such as resin or glass substrates, with transparent electrodes 113 and 114 respectively thereon. The substrates 112 are bonded together by resin nodules. On the transparent electrodes 113 and 114, an insulating layer 118 and an alignment controlling layer 119 are provided if necessary. Also, in the periphery of the substrates 112 (outside of a displaying area), a sealant 120 is provided to seal the liquid crystal 116 between the substrates 12.

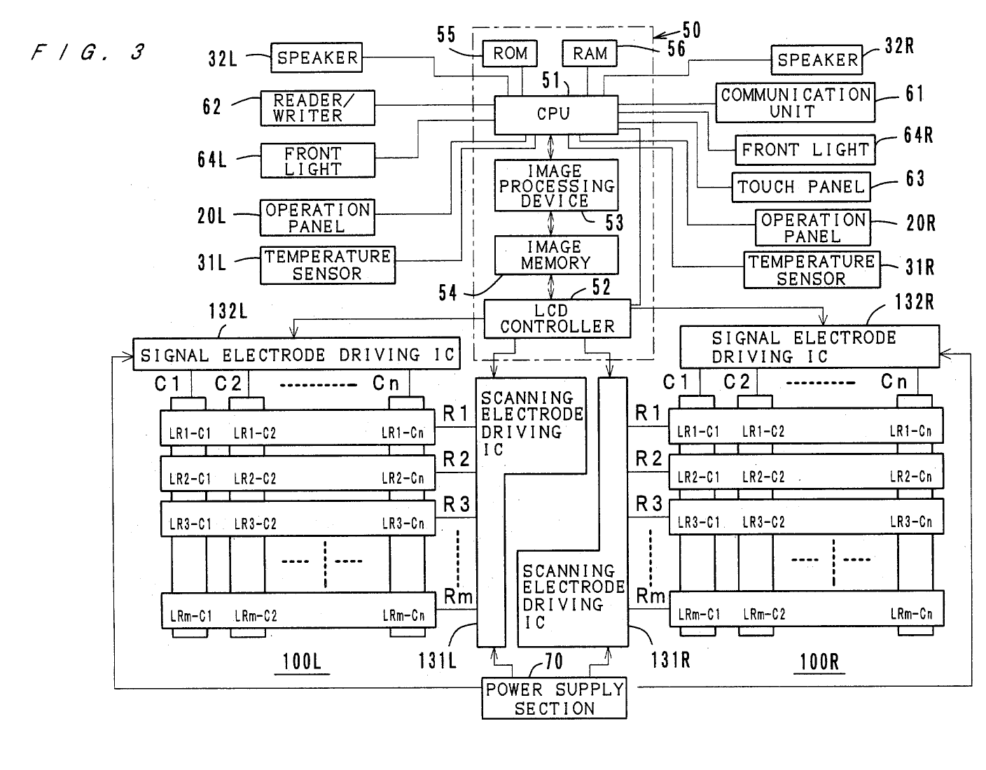

As FIG. 3 shows, the transparent electrodes 113 and 114 are connected to a scanning electrode driving IC 131R or 131L and a signal electrode driving IC 132R or 132L, respectively, and specified pulse voltages are applied to the transparent electrodes 113 and 114. In response to the voltages, the liquid crystal 116 switches between a transparent state to transmit visible light and a selective reflection state to selectively reflect light of a specified wavelength, and thereby, a display is made.

In each of the display layers 111R, 111G and 111B, the transparent electrodes 113 and 114 each comprises strip-like electrodes which are arranged in parallel at fine intervals. The strip-like electrodes 113 and the strip-like electrodes 114 face each other, and the extending direction of the strip-like electrodes 113 and the extending direction of the strip-like electrodes 114 are perpendicular to each other viewing from the top. Electricity is applied to the upper and lower electrodes sequentially. In other words, a voltage is applied to the liquid crystal 116 in a matrix way for writing of an image. This is referred to as matrix driving, and the intersections between the electrodes 113 and 114 serve as pixels. By matrix-driving each of the display layers in this way, a full-color image can be written on the liquid crystal display 100.

A liquid crystal display which has liquid crystal which exhibits a cholesteric phase between two substrates makes a display by switching the liquid crystal between a planar state and a focal-conic state. When the liquid crystal is in a planar state, the liquid crystal selectively reflects light of a wavelength λ=P↑n (P: helical pitch of the cholesteric liquid crystal, n: average refractive index of the liquid crystal). When the liquid crystal is in a focal-conic state, if the wavelength of light to be selectively reflected by the liquid crystal is within the infrared spectrum, the liquid crystal scatters incident light, and if the wavelength of light to be selectively reflected by the liquid crystal is shorter than the infrared spectrum, the liquid crystal scatters incident light very weakly and substantially transmits visible light. Accordingly, if the wavelength of light to be reflected by the liquid crystal is set within the visible spectrum and if a light absorbing layer is provided on the opposite side of the liquid crystal display to the observing side, when the liquid crystal is in a planar state, an observer can see a display of the color corresponding to the wavelength of light selectively reflected by the liquid crystal, and when the liquid crystal is in a focal-conic state, an observer can see a display of black. Also, if the wavelength of light to be reflected by the liquid crystal is set within the infrared spectrum and if a light absorbing layer is provided on the opposite side of the liquid crystal display to the observing side, when the liquid crystal is in a planar state, an observer can see a display of black because the liquid crystal reflects infrared light but transmits visible light, and when the liquid crystal is in a focal-conic state, an observer can see a display of white because the liquid crystal scatters light.

In the liquid crystal display 100 with the display layers 111R, 111G and 111B laminated, when the blue display layer 111B and the green display layer G are in a transparent state wherein the liquid crystal is in a focal-conic alignment and when the red display layer 111R is in a selective reflection state wherein the liquid crystal is in a planar alignment, a display of red is made. When the blue display layer 111B is in a transparent state wherein the liquid crystal is in a focal-conic alignment and when the green display layer 111G and the red display layer 111R are in a selective reflection state wherein the liquid crystal is in a planar alignment, a display of yellow is made. In such a way, by setting each of the display layers to a transparent state or a selective reflection state appropriately, displays of red, green, blue, white, cyan, magenta, yellow and black are possible. Further, by setting each of the display layers to an intermediate selective reflection state, display of intermediate colors are possible. Thus, the liquid crystal display 100 can be used as a full-color display.

As the liquid crystal 116, preferably, liquid crystal which exhibits a cholesteric phase at room temperature is used, and especially, chiral nematic liquid crystal which can be obtained by adding a sufficient amount of chiral agent to nematic liquid crystal is suited.

A chiral agent, when it is added to nematic liquid crystal, twists molecules of the nematic liquid crystal. When a chiral agent is added to nematic liquid crystal, liquid crystal molecules are formed into a helical structure with uniform twist intervals, and thereby, the liquid crystal exhibits a cholesteric phase.

Further, by using such chiral nematic liquid crystal as a display medium, an image displayed thereon can be kept almost parmanently even while no voltages are applied thereto. In other words, a liquid crystal display panel with a memory effect can be obtained. Therefore, even while the control section 50 is in a sleep mode, the liquid crystal display apparatus 10 can keep displaying an image.

The liquid crystal display layers are not necessarily of the above-described structure. The resin nodules may be walls or may be omitted. The liquid crystal display layers may be a polymer-dispersed type liquid crystal composite layer wherein liquid crystal is dispersed in a conventional three-dimensional polymer net or wherein a three-dimensional polymer net is formed in liquid crystal.

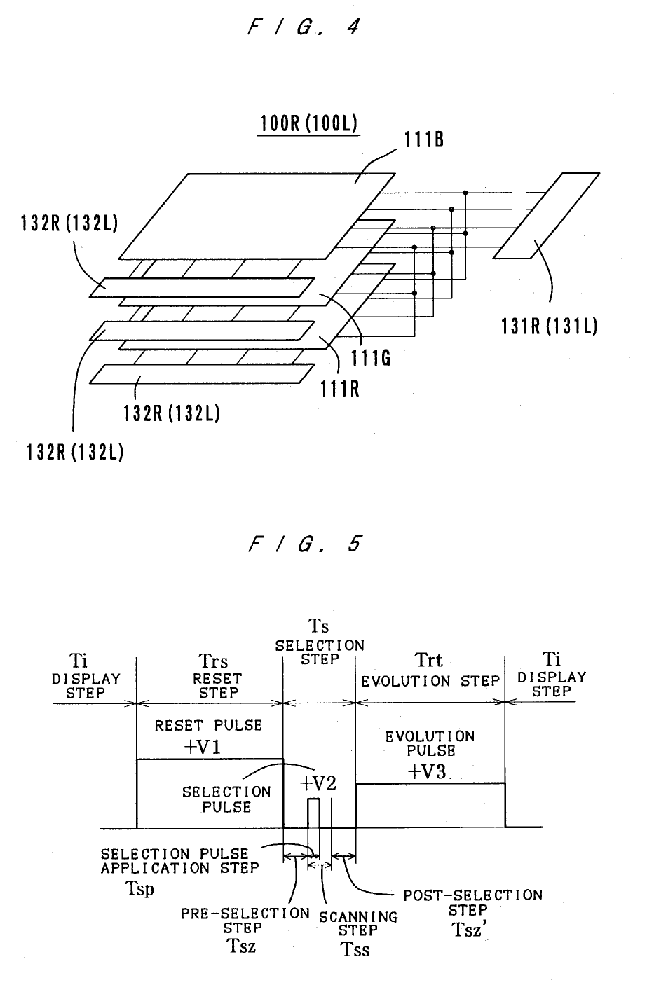

### Control Section and Driving Circuit; See FIGS. 3 and 4

As FIG. 3 shows, the pixels of each of the liquid crystal displays 100R and 100L are formed into a matrix which is composed of a plurality of scanning electrodes R1, R2 through Rm and a plurality of signal electrodes C1, C2 through Cn (m, n: natural numbers). The scanning electrodes R1, R2 through Rm of the display 100R and those of the display 100L are connected to output terminals of the scanning electrode driving ICs 131R and 131L respectively, and the signal electrodes C1, C2 through Cn of the display 100R and 100L are connected to output terminals of the signal electrode driving ICs 132R and 132L respectively.

Each of the scanning electrode driving ICs 131R and 131L sends a selection signal to a specified one of the scanning electrodes R1, R2 through Rm while sending non-selection signals to the other scanning electrodes. The scanning electrode driving ICs 131R and 131L send the selection signals to the scanning electrodes R1, R2 through Rm sequentially switching at uniform time intervals. In the meantime, each of the signal electrode driving ICs 132R and 132L sends a signal in accordance with image data to all the signal electrodes C1, C2 through Cn simultaneously so as to carry out writing on the pixels in the scanning electrode in a selected state. For example, when a scanning electrode Ra (a: natural number, a≦m) is selected, writing is carried out simultaneously on the pixels Lra-C1 through Lra-Cn at the intersections between the scanning electrode Ra and the signal electrodes C1, C2 through Cn. At this time, in each of the pixels, the voltage difference between the scanning electrode and the signal electrode works as a writing voltage, and writing is carried out in each of the pixels in accordance with the writing voltage.

Writing of an image is carried out by selecting all the scanning lines sequentially. When the screen is to be partly renewed, the scanning lines in a specified area including the part to be renewed shall be selected in order. Thereby, writing on only the necessary part can be carried out for a short time.

The control section 50 comprises a CPU 51 for controlling the apparatus 10 entirely, an LCD controller 52 for controlling the driving ICs, an image processing device 53 for carrying out various kinds of processing toward image data, an image memory 54 for storing image data, a ROM 55 stored with control programs and various kinds of data and a RAM 56 for storing various kinds of data.

To the CPU 51, the operation panels 20R and 20L, the temperature sensors 31R and 31L, the speakers 32R and 32L, a communication unit 61, a reader/writer 62 of the storage medium 35, a touch panel 63 and front lights 64R and 64L are connected. These devices send and receive necessary signals to and from the CPU 51 and are controlled by the CPU 51.

To the driving ICs 131R, 131L 132R and 132L, electric power is supplied from the power supply section 70. The LCD controller 52 controls the driving ICs 131R, 131L, 132R and 132L in accordance with image data stored in the image memory 54. Accordingly, voltages are applied to the scanning electrodes and the signal electrodes of the liquid crystal displays 100R and 100L, and thereby, images are written on the displays 100R and 100L. The CPU 51 also reads in information about the circumstantial temperatures from the temperature sensors 31R and 31L and temporarily stores the information in the RAM 56. In the ROM 55, information for determining the setting conditions of a selection pulse application step Tsp and a seleciton step Ts, which will be described later, in accordance with the circumstantial temperatures are stored.

The CPU 51 is operable in a sleep mode. When necessary processing such as renewal of a screen, communication with an external device, an access to the storage medium 35, etc. is completed, the CPU 51 comes to the sleep mode. In the sleep mode, the CPU 51 carries out only minimum essential functions, such as detection of operation of the operation panels 20R and 20L, etc. and stops the other functions for power saving.

As FIG. 4 shows, the scanning electrode driving ICs 131R and 131L are shared by the display layers, and the signal electrode driving ICs 132R and 132L are provided for each of the display layers. On the condition that the driving voltages of the display layers are almost equal to each other, the scanning electrode driving ICs 131R and 131L can be shared by the display layers, and this is advantageous in cost. The scanning electrode driving ICs 131R and 131L can be provided for each of the display layers, and the signal electrode driving ICs 132R and 132L may be shared by the display layers.

In the following, a driving method will be described in connection with one of the display layers; it is, however, to be noted that the same driving method is adopted also to drive the other display layers.

### Driving Principle and Basic Driving Wave; See FIG. 5

First, the principles of a method of driving the liquid crystal displays are described. In the following, basic driving waves which use pulses with a positive polarity will be described; however, pulses with a negative polarity or alternating pulses may be used.

FIG. 5 shows basic driving pulses which are outputted from the scanning electrode driving ICs 131R and 131L and applied to the scanning electrodes. This driving method generally comprises a reset step Trs, a selection step Ts, an evolution step Trt and a display step (crosstalk step) Ti. The selection step Ts comprises a selection pulse application step Tsp, a pre-selection step Tsz and a post-selection step Tsz′. The time calculated by Ts−(Tsz+Tsz′) is a scanning time Tss.

In the basic driving waves, in the reset step, a reset pulse of +V1 is applied. In the selection pulse application step Tsp of the selection step Ts, a selection pulse of +V2 is applied. In the pre-selection step Tsz and the post-selection step Tsz′, 0v is applied. Further, in the evolution step Trt, an evolution pulse of +V3 is applied.

The state of the liquid crystal is described. When the reset pulse of +V1 is applied in the reset step Trs, the liquid crystal is reset to a homeotropic state. In the pre-selection step Tsz, the liquid crystal is twisted a little, and the liquid crystal comes to the selection pulse application step Tsp. Depending on the waveform of the selection pulse applied in this step Tsp, it is determined whether the pixel finally comes to a planar state, a focal-conic state or an intermediate state (display of an intermediate tone).

First, a case of selecting a planar state as the final state of a pixel is described. In the selection pulse application step Tsp, a selection pulse with a specified level of energy is applied, and thereby, the liquid crystal comes to a homeotropic state again. Thereafter, in the post-selection step Tsz′, the liquid crystal is twisted a little. Next, in the evolution step Trt, the evolution pulse of +V3 is applied, and thereby, the liquid crystal, which was twisted a little in the post-selection step Tsz′, is untwisted and comes to a homeotropic state again. Then, the liquid crystal in a homeotropic state comes to a planar state when the voltage applied thereto becomes 0V, and the liquid crystal in a planar state stays in the same state.

On the other hand, in a case of selecting a focal-conic state as the final state of a pixel, in the selection pulse application step Tsp, a selection pulse with a lower level of energy is applied. Specifically, the energy level of the selection pulse here is lower than the level of the selection pulse to select a planar state. Thereafter, in the post-selection step Tsz′, the liquid crystal is twisted to an extent where the helical pitch is widened approximately double.

Thereafter, in the evolution step Trt, the evolution pulse of +V3 is applied, and thereby, the liquid crystal, which was twisted in the post-selection step, comes to a focal-conic state. The liquid crystal in afocal-conic state stays in the same state even after the voltage applied thereto becomes 0V.

As has been described, the final state of the liquid crystal can be selected by altering the energy level of the selection pulse applied in the selection pulse application step Tsp. Also, by adjusting the voltage and the pulse width of the selection pulse, displays of intermediate tones are possible.

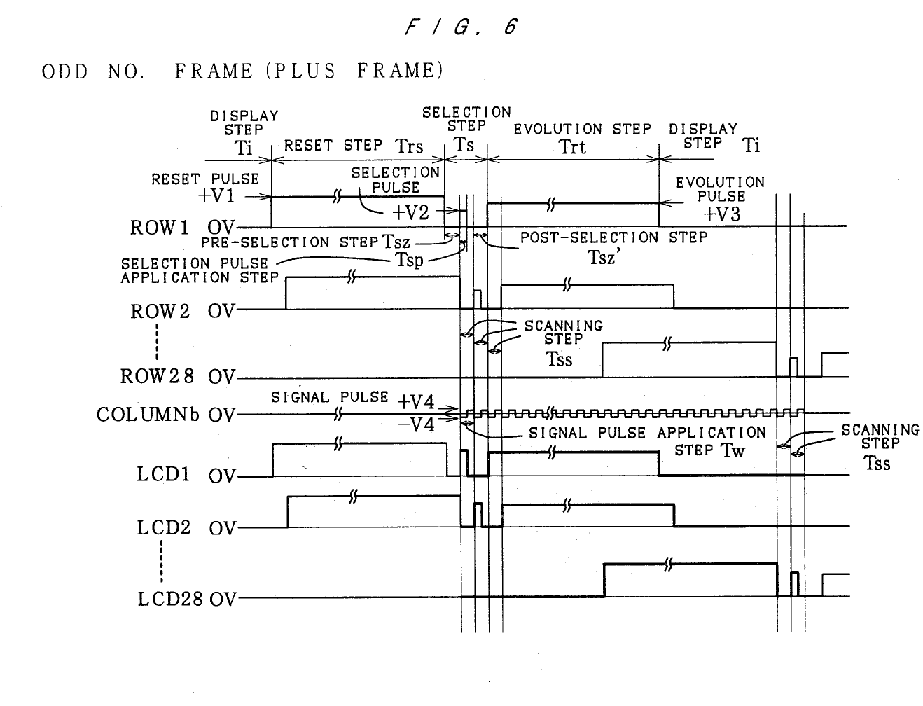

### Driving Example; See FIGS. 6 through 10

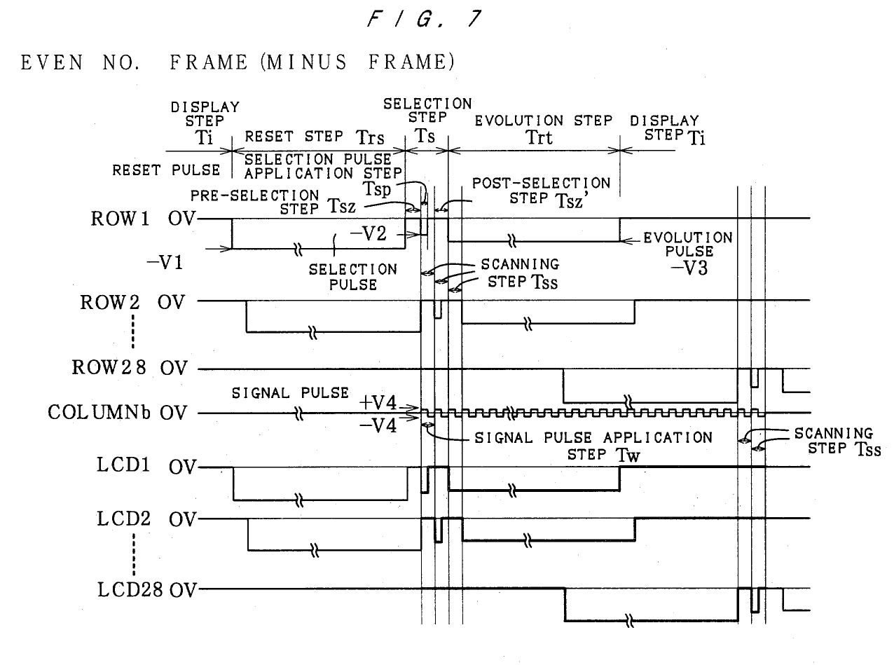

FIGS. 6 and 7 show pulse waves which are outputted from the scanning electrode driving ICs 131R and 131L and applied to the scanning electrodes (ROW 1, ROW 2 through ROW 28), pulse waves which are outputted from the signal electrode driving ICs 132R and 132L and applied to a signal electrode (COLUMN b) and pulse waves which act on the pixels (LCD 1, LCD 2 through LCD 28) due to the superposition of the pulse waves applied to the scanning electrodes and the pulse waves applied to the signal electrode.

In this driving example, every after writing of one frame, the polarity of pulse waves is inverted. FIG. 6 shows driving waves for writing of a frame of an odd number in which pulse waves with the positive polarity are applied, and FIG. 7 shows driving waves for writing of a frame of an even number in which pulse waves with the negative polarity are applied.

The scanning electrode driving ICs 131R and 131L apply a plurality of voltages which are supplied from the power supply section 70, namely, reset voltages (+V1, −V1), selection voltages (+V2, −V2 ) and evolution voltages (+V3, −V3) to the scanning electrodes R1, R2 through Rm. For example, the reset pulse voltages are for example, +40V and −40V, the selection pulse voltages are +15V and −15V, and the evolution pulse voltages are +25V and −25V

The signal electrode driving ICs 132R and 132L applies writing signal voltages ±V4 which are supplied from the power supply section 70 to the signal electrodes C1, C2 through Cn. For example, the writing signal pulse voltages are +3V and −3V.

In FIGS. 6 and 7, while driving pulses are applied to the plurality of scanning electrodes (ROW 1, ROW 2 through ROW 28) sequentially in accordance with the selection signal, the writing signal pulses are applied to one of the signal electrodes (COLUMN b).

For simplification of illustration, here, the signal pulses applied to COLUMN b have an energy level to select the selective reflection state of liquid crystal in all the scanning steps Tss. In actually writing an image, the waveforms of the writing signal pulses depend on image data, and in each scanning step Tss, a pulse with a waveform to select a transparent state, a selective reflection state or an intermediate state is applied.

By applying the above-described driving pulses, pulse voltages shown in FIGS. 6 and 7 act on the respective pixels LCD 1, LCD 2 through LCD 28. Further, the writing signal pulses act on the respective pixels through the signal electrodes as crosstalk pulses. In FIGS. 6 and 7, bold lines indicate the pulse voltages during the steps where crosstalk pulses are applied. However, the voltage of the crosstalk pulses is too low to substantially influence the liquid crystal. Therefore, in writing of one frame, substantially pulses with only one polarity are applied to the liquid crystal.

In the reset step Trs, a reset pulse of +V1 (in a frame of an odd number) or of −V1 (in a frame of an even number) is applied. In the selection pulse application step Tsp of the selection step Ts, a selection pulse of +V2 (in a frame of an odd number) or of −V2 (in a frame of an even number) is applied. In the selection pulse application step Tsp, writing signal pulses of ±V4 are also applied from the signal electrode driving IC 132R or 132L. The voltages ±V4 of the writing signal pulses are set in accordance with image data. The writing signal pulses are here rectangular pulses which have the same absolute value respectively in the positive and negative polarities at a duty factor of 50% within a signal pulse application step Tw.

In the pre-selection step Tsz and in the post-selection step Tsz′, 0V is applied. In the evolution step Trt, an evolution pulse of +V3 (in a frame of an odd number) or of −V3 (in a frame of an even number) is applied.

In this driving example, selection of the scanning electrodes is carried out based on the length of the scanning step Tss, and at the end of the scanning step Tss of a scanning electrode, the selection pulse application step Tsp of the next scanning electrode starts.

In this driving example, also, the polarity of the driving pulses applied to the scanning electrodes is fixed during writing of one frame, and the polarity depends on whether the frame is a frame of an odd number or a frame of an even number. The polarity is inverted for writing of every frame. Thus, voltages with one polarity are applied during writing of one frame, and the duration when one polarity is continued is relatively long. Compared with a case of applying alternating voltages of which polarities alternate at a very high frequency, in this case, the repeating frequency of voltages applied to the liquid crystal can be lowered, and the voltages of the driving pulses applied to the scanning electrodes can be lowered to a half. Therefore, the power consumption of the power supply section 70 is largely reduced.

This driving example is applicable to progressive scanning where scanning lines are scanned one by one progressively and to interlace scanning where one frame is divided into a plurality of fields and scanning lines are scanned with some lines skipped. In a case of interlace scanning, occurrences of black stripes, which are caused by the fact that the light absorbing layer 121 on the background is seen black when the liquid crystal substantially stays in a transparent state from the start of application of a reset pulse to the end of application of an evolution pulse, can be suppressed, and during writing on the liquid crystal, the screen is easy to see.

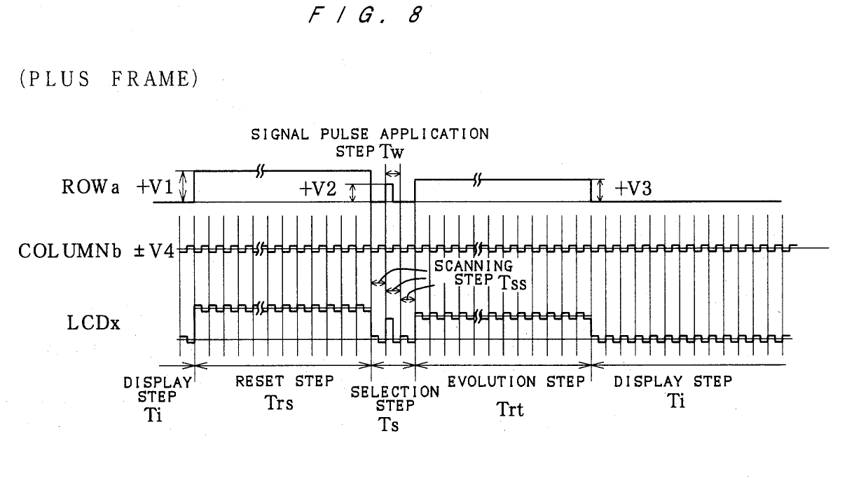

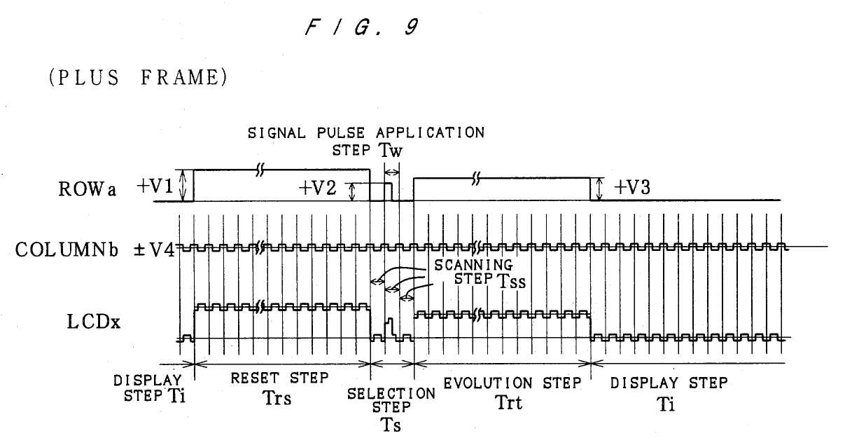

Next, referring to FIGS. 8 through 10, the driving waveform in the above-described example is described in detail. Each of FIGS. 8 through 10 shows a case of writing in a frame of an odd number (plus frame) and shows pulses applied to a selected ROW a of ROW 1 through ROW 28, writing signal pulses applied to COLUMN b and voltage waves including crosstalk pulses which are caused by superposition of the pulses applied to ROW a and the pulses applied to COLUMN b and which act on the pixel LCD x. FIG. 8 shows a case of selecting the pixel LCD x to finally come to a maximum selection reflective state. FIG. 9 shows a case of selecting the pixel LCD x to finally come to an intermediate state. FIG. 10 shows a case of selecting the pixel LCD x to finally come to a transparent state.

Specifically, by changing the phase of the signal pulses of ±V4, the waveform of the pulse which is applied to the pixel LCD x in the selection step Ts is changed, and thereby, the final state of the pixel LCD x can be determined to be a planar state, a focal-conic state or an intermediate state.

Here, the duration Tsp of the selection pulse applied to ROW a is a half of the scanning time Tss, and the signal pulses which are applied to COLUMN b during the signal pulse application step Tw are rectangular pulses which have duty factors of 50% respectively and which have the same absolute value respectively in the positive and negative polarities.

As the bold lines in FIGS. 6 and 7 show, all the pixels are influenced by crosstalk due to the signal pulses applied to the signal electrodes. In this embodiment, however, since the signal pulses applied to COLUMN b are rectangular pulses which have duty factors of 50% respectively and which have the same absolute value respectively in the positive and negative polarities, the voltage which actually acts on the liquid crystal in the reset step Trs and that in the evolution step Trt are √{[(V1+V4)2+(V1−V4)2]/2} and √{[(V3+V4)2+(V3−V4)2]/2}, and thus constant voltages act on the liquid crystal in the reset step Trs and in the evolution step Trt.

Therefore, although crosstalk pulses influence the liquid crystal of the pixels, substantially constant voltages act on the respective pixels, and shadowing which is usually caused by crosstalk pulses can be inhibited.

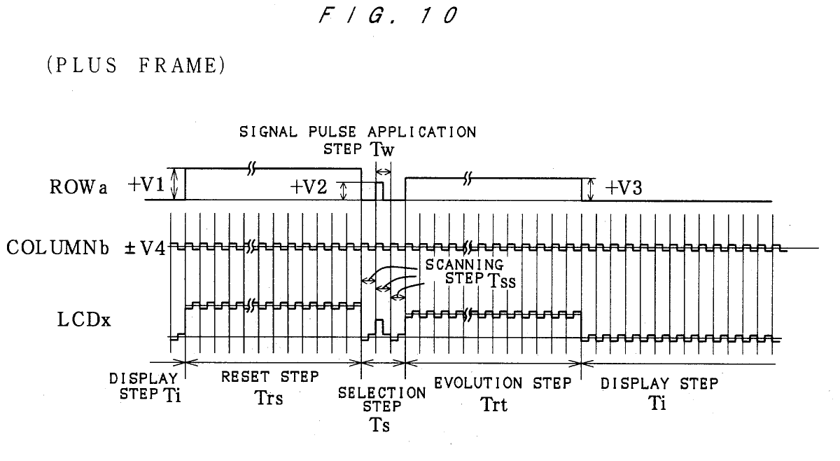

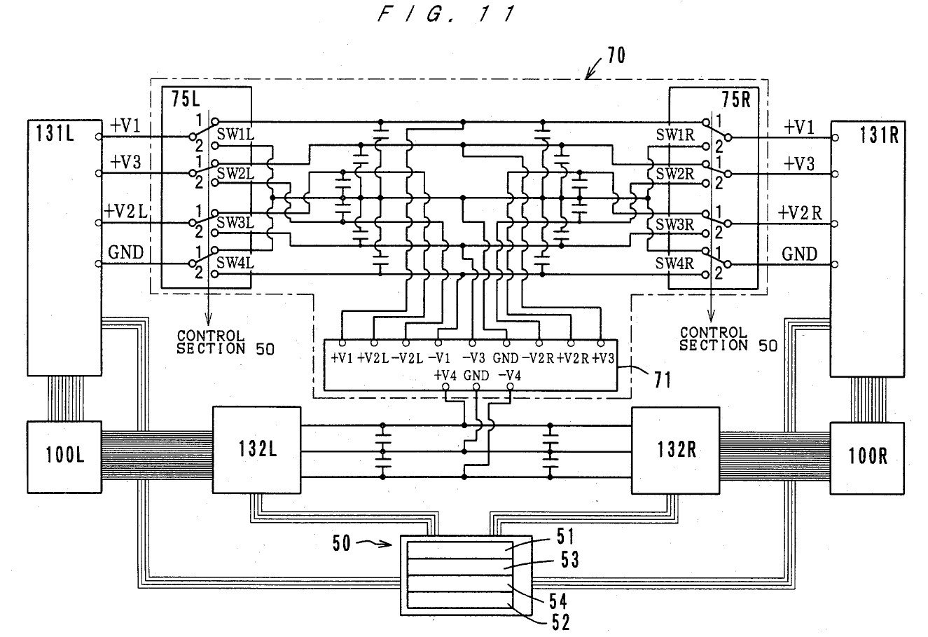

### Details of Power Supply Section; See FIGS. 11 and 12

FIGS. 11 and 12 show the power supply section 70 in details. The power supply section 70 comprises a power source 71, power switching circuits 75R and 75L and capacitors. The power source 71 has nine terminals which permit supply of driving pulses of specified voltages, namely, +V1, +V2L, −V2L, −V1, −GND, −V2R, +V2R and +V3, to the scanning electrode driving ICs 131R and 131L. The power source 71 also has three terminals which permit supply of signal pulses of specified voltages, namely, +V4, GND and −V4, to the signal electrode driving ICs 132R and 132L. The voltages of the pulses which are outputted from these terminals are finely adjustable within a specified range.

The power switching circuits 75R and 75L have respectively four switching elements SW1R through SW4R and SW1L through SW4L. The respective one ends of these switching elements are connected to specified terminals of the scanning electrode driving ICs 131R and 131L, and the other ends are connected to the terminals of the power source 71.

The terminals for ±V1, ±V3 and GND are connected to the switching circuits 75R and 75L in parallel. The terminals for the selection pulses of ±V2R and ±V2L are connected to the switching circuits 75R and 75L independently. The characteristics of the liquid crystal displays 100R and 100L are measured beforehand, and the voltages ±V2R and ±V2L are determined so as to offset the differences in the characteristics. Fine adjustment of these voltages may be carried out before delivery of the apparatus or may be carried out by the user of the apparatus.

Also, logic level shifters are provided in the scanning electrode driving ICs 131R and 131L so that if the voltage GND shifts from 0V, it can be returned to 0V.

In the middles of connection lines which supply the driving pulse voltages +V1, +V2L, −V2L, −V1, −V3, −V2R, +V2R and +V3 to the scanning electrode driving ICs 131R and 131L, capacitors connected to the terminal GND are provided for stabilization of the respective voltages. Also, in the middles of connection lines which supply the signal pulse voltages +V4 and −V4 to the signal electrode driving circuits 132R and 132L, capacitors connected to the terminal GND are provided for stabilization of the respective voltages.

FIG. 11 shows a case where the driving pulses applied to the liquid crystal displays 100R and 100L are of the positive polarity, and FIG. 12 shows a case where the driving pulses are of the negative polarity. Both the application of driving pulses of the positive polarity and the application of driving pulses of the negative polarity are realized by controlling the switching elements in the power switching circuits 75R and 75L by order of the CPU 51.

More specifically, the switching elements SW1LR through SW4R and SW1L through SW4L are simultaneously switched to the positive side (to contact points 1 as shown by FIG. 11) or to the negative side (to contact points 2 as shown by FIG. 12).

While the switching elements are on the contact points 1, positive voltages +V1, +V2R and +V3 are supplied from the power source 71 to the scanning electrode driving IC 131R which drives the right side liquid crystal display 100R, and positive voltages +V1, +V2L and +V3 are supplied from the power source 71 to the scanning electrode driving IC 131L which drives the left side liquid crystal display 100L.

While the switching elements are on the contact points 2, negative voltages −V1, −V2R and −V3 are supplied from the power source 71 to the scanning electrode driving IC 131R which drives the right side liquid crystal display 100R, and negative voltages −V1, −V2L and −V3 are supplied from the power source 71 to the scanning electrode driving IC 131L which drives the left side liquid crystal display 100L.

In the driving circuit with the above-described power supply section 70, the control section 50 switches the polarity of the voltages supplied to the scanning electrode driving ICs 131R and 131L to the positive side and to the negative side alternately every after writing of one frame. Thereby, the polarity of the driving pulses during writing of one frame is constant while being switched between the positive side and the negative side alternately for writing of each frame. With this simple driving circuit and by this control method, trouble such as deterioration of liquid crystal can be prevented.

In this driving circuit, also, the voltages ±V2 are supplied to the liquid crystal displays 100R and 100L respectively from mutually independent power source terminal, and therefore, differences in characteristics (thickness and composition of the liquid crystal layer) between the liquid crystal displays 100R and 100L can be easily compensated. Also, a difference in display performance between the right and left liquid crystal displays 100R and 100L due to a difference between the circumstantial temperature of the liquid crystal display 100R and that of the liquid crystal display 100L (for example, when a battery is provided in only either one of the frames of the liquid crystal displays 100R and 100 L, the circumstantial temperatures of the liquid crystal displays 100R and 100 L become different from each other due to heat generated from the battery) can be easily compensated.

Further, in this driving circuit, the polarities of the voltages supplied to the scanning electrode driving ICs 131R and 131L are switched by the power switching circuits 75R and 75L, and therefore, as the scanning electrode driving ICs 131R and 131L, inexpensive four-value ICs with low withstand voltages can be used.

In the above-described driving example, the polarity of the driving pulses is inverted every after writing of one frame; however, the polarity inversion may be carried out at any other times. For example, if the liquid crystal does not degrade easily or if degradation of the liquid crystal to some extent is tolerable, the polarity inversion may be carried out every after writing of several frames. On the other hand, if degradation of liquid crystal is desired to be minimized, the polarity inversion may be carried out during scanning of each line, every after scanning of one line, every after scanning of several lines, every after scanning of one field or every after scanning of several fields.

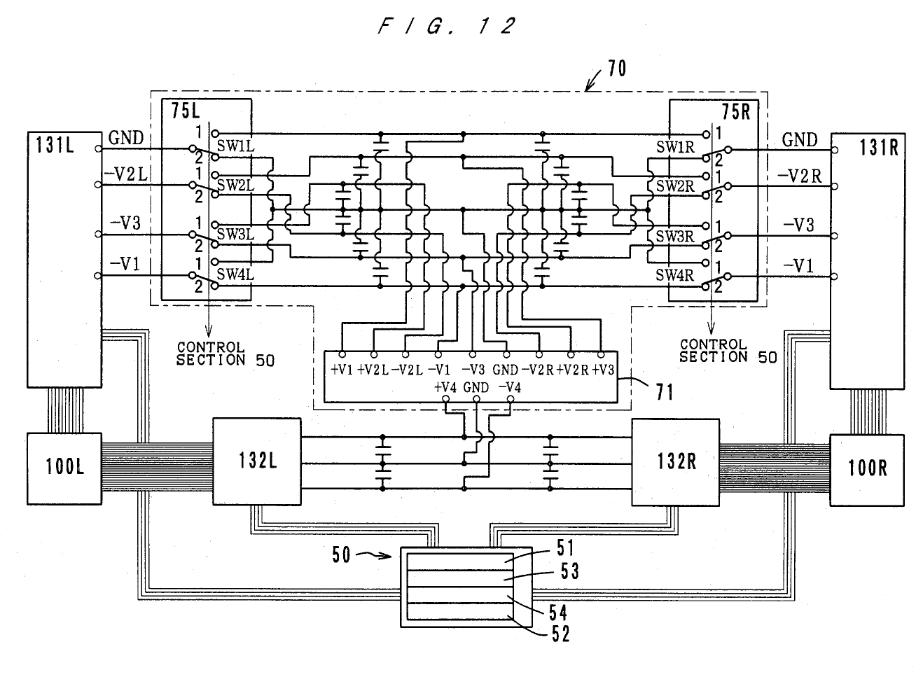

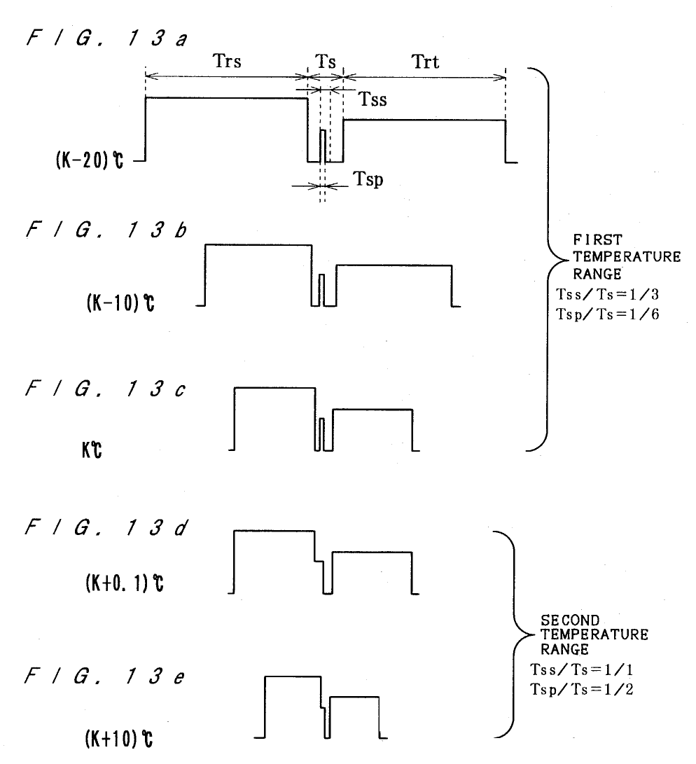

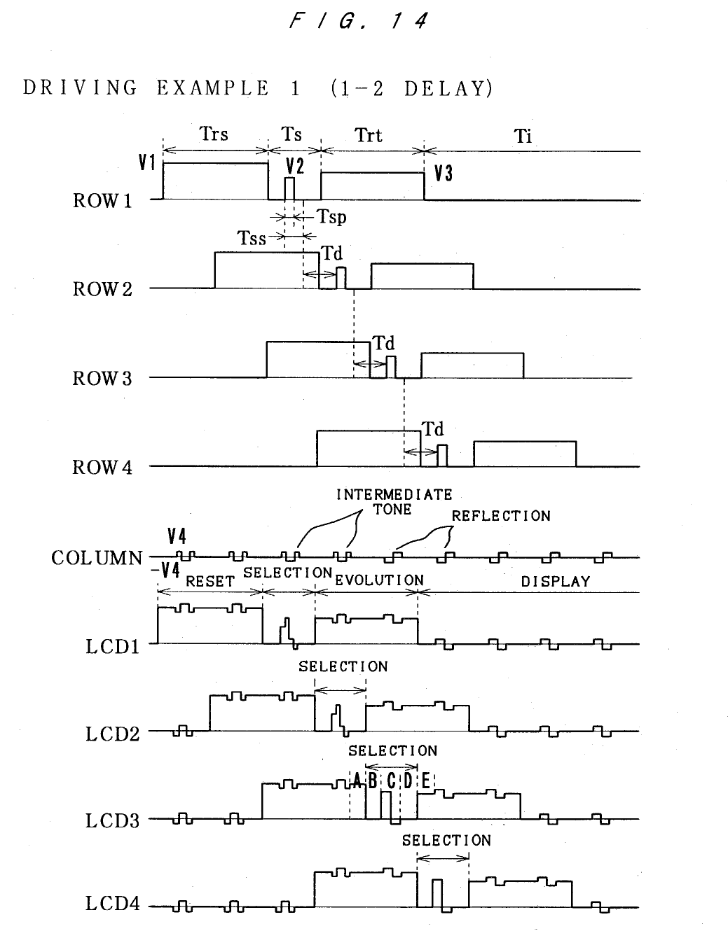

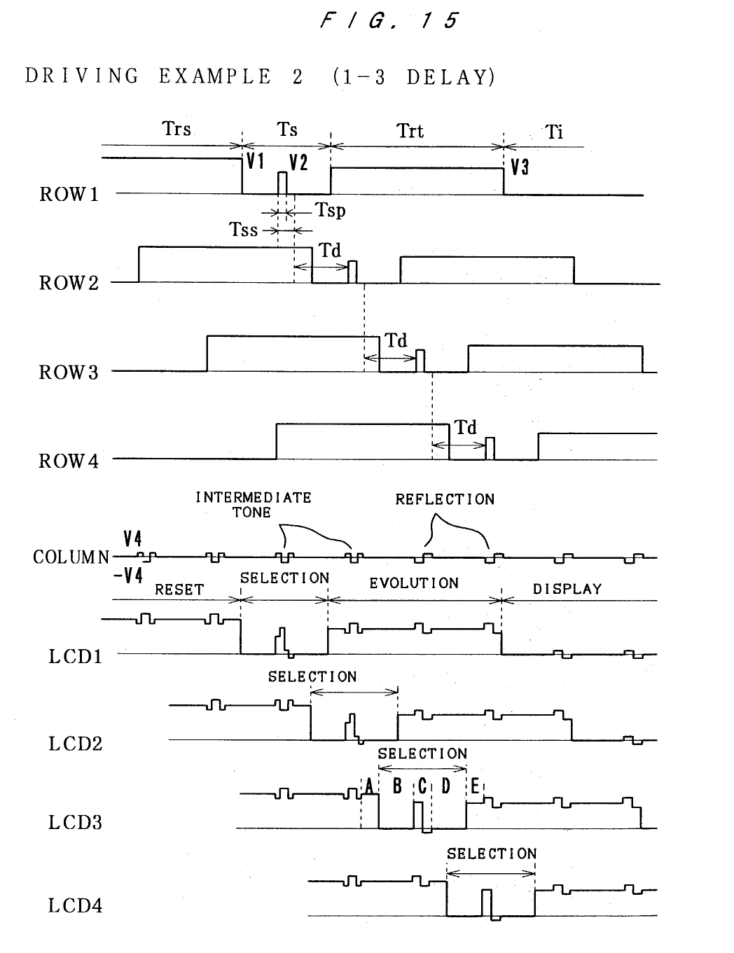

### Relationship between Temperature and Driving Frequency; See FIG. 13

As has been described, chiral nematic liquid crystal changes its responsibility to driving pulses in accordance with temperature. Specifically, the response speed of chiral nematic liquid crystal is low in a low temperature range and is high in a high temperature range. In this embodiment, therefore, the length of a cycle of driving pulses (the reset pulse, the selection pulse, the evolution pulse and the writing signal pulse) which are applied to the liquid crystal displays 100R and 100L is changed intermittently in accordance with the circumstantial temperatures detected by the temperature sensors 31R and 31L, while the ratio of the pulse widths of the driving pulses to one another is kept constant.

More specifically, the response speed of the liquid crystal becomes high as the temperature rises, and therefore, the length of the scanning step Tss which corresponds to the time required for scanning of one line is set shorter as the temperature becomes high. Accordingly, the lengths of the reset step Trs, the selection step Ts and the evolution step Trt are changed at the same rate. Such a change is carried out, for example, by order of the CPU 51 and realized by changing the frequency of a basic clock signal which is generated by a basic clock signal generating means, which is, for example, incorporated in the LCD controller 52. Alternatively, the count-up number and/or the dividing rate of a clock signal may be heightened or lowered.

FIG. 13 shows a way of changing the length of a cycle of driving pulses in accordance with circumstantial temperature. In a first temperature range from (K−20)° C. to K° C., as the temperature rises, the length of a cycle of driving pulses is shortened while the condition Tss/Ts=1/3 (Tsp/Ts=1/6) is fulfilled. In a second temperature range over K° C. to (K+10)° C., as the temperature rises, the length of a cycle of driving pulses is shortened while the condition Tss/Ts=1/1 (Tsp/Ts=1/2) is fulfilled. In the case of FIG. 13, the temperature detection is carried out by the 0.1° C.

In cases of changing the length of a cycle of driving pulses, as described above, while the rate Tss/Ts may be changed intermittently at borders among the temperature ranges, the rate Tss/Ts may be kept constant in each temperature range. Also, while the rate Tss/Ts may be changed intermittently at borders among the temperature ranges, the rate Tss/Ts may be changed gradually in each temperature range. In the former case, the control is easy, and in the latter case, the control is more sensitive to changes in temperature.

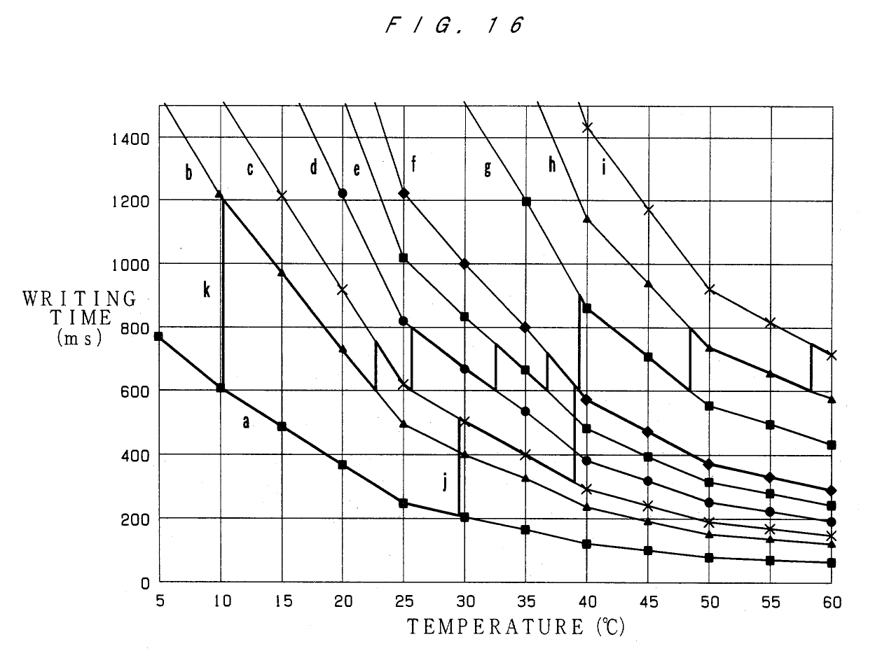

### Driving Example 1 in Delayed Scanning Mode; See FIG. 14

Next, a driving example 1 in a delayed scanning mode is described. In the delayed scanning mode, in either case of progressive scanning and interlace scanning, a delay step Td is inserted between scanning of a line and scanning of a next scanned line. In the driving example 1, as FIG. 14 shows, the delay step Td has a length of two units (one unit=the length of the scanning step Tss), and this is called as 1-2 delay.

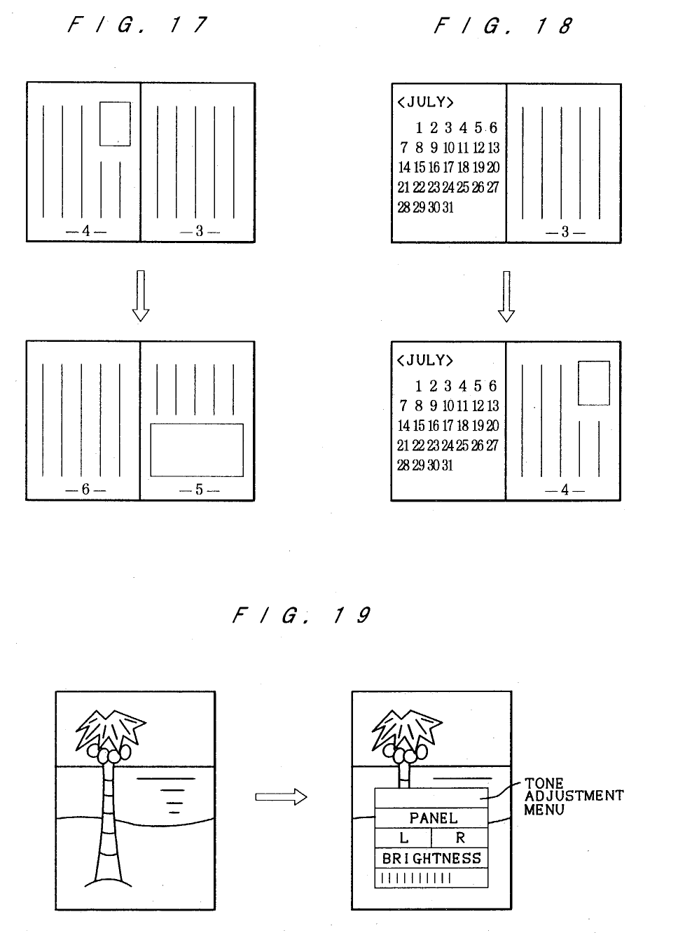

FIG. 14 (FIG. 15 also) shows basic driving waves applied to scanning electrodes ROW 1 through ROW 4 and signal waves applied to a signal electrode COLUMN. Also, pulse waves which act on the liquid crystal of pixels LCD 1 through LCD 4 are shown.

The driving example 1 is to drive liquid crystal under the same principles of the driving example shown by FIGS. 5 through 10. In the driving example 1, a delay step Td with a length of two units is inserted in scanning of every scanning line. The delay step Td is to delay the time of applying pulses to each scanning electrode by a time of two units and to delay the time of applying pulses to the signal electrodes in synchronization with the time of application of pulses to each scanning electrode. The delay step Td is realized by keeping the scanning electrode and the signal electrodes at 0V

By inserting delay steps Td with a length of two units or more, influence of crosstalk can be avoided, and degradation of picture quality can be effectively inhibited. In order to describe this effect, the pixel LCD 3 in the driving example 1 is focused on. On the pixel LCD 3, in the ending part of the reset step A, in the pre-selection step B, in the post-selection step D and in the beginning part of the evolution step E, crosstalk does not occur. The present inventors founded out the following things. When crosstalk occurs in the parts A, B, D and E, the density to be finally displayed is influenced by the densities of the pixels which are subjected to writing, and in cases of displaying an image and letters, the influence is seen as ghost. This phenomenon is remarkable when crosstalk occurs in the end part of the reset step or in the beginning part of the evolution step, and further ghost is more remarkable when crosstalk occurs in the pre-selection step and in the post-selection step than when crosstalk occurs in the reset step and in the evolution step. In the driving example 1, by delaying the selection pulse application step Tsp of every scanning line by a time of two units, on every scanning line, application of crosstalk pulses in the parts A, B, D and E can be avoided. Consequently, ghost, which is caused by crosstalk in the parts A, B, D and E, can be prevented.

### Driving Example 2 in Delayed Scanning Mode; See FIG. 15

Next, a driving example 2 in a delayed scanning mode is described. In the driving example 2, as FIG. 15 shows, the delay step Ts has a length of three units (one unit=a length of the scanning step Tss), and this is called as 1-3 delay.

In this driving example 2, also, when the pixel LCD 3 is focused on, crosstalk does not occur in the parts A, B, D and E.

### Changes of Delay Step and Tss/Ts in Accordance with Temperature; See FIG. 16

Now, control to change the length of the delay step Td and the rate of Tss/Ts, which has been already described with reference to FIG. 13, in accordance with temperature is described.

By using a cycle of driving pulses (a reset pulse, a selection pulse and an evolution pulse) with specified fixed voltages and a specified fixed ratio of the respective pulse widths, the lengths of the whole cycle of driving pulses which are suited for a display of an appropriate density at various circumstantial temperatures are measured beforehand. Based on the measurement, a characteristic curve which shows the suitable lengths of the whole cycle of driving pulses at various circumstantial temperatures are formed. In this stage, also, by changing the length of the delay step Td and the rate Tss/Ts (Tsp/Ts), a plurality of characteristic curves are formed. Then, when the apparatus is actually used, by selecting one from the characteristic curves in accordance with the temperature, renewal of the screen can be carried out without largely lengthening the writing time and without largely increasing the peak current flowing in the driving circuit.

FIG. 16 shows characteristic curves a through i which were formed in the above-described way and which are the basis of control. In the graph of FIG. 16, the x axis indicates circumstantial temperature, and the y axis indicates time required for writing on the screen (writing time). Here, the writing time is the time from application of a selection pulse to the first scanning line to completion of application of a selection pulse to the last scanning line. The respective characteristic curves a through i are for the following specs shown by table 1. The characteristic curves shown in FIG. 16 were formed under the conditions that the reset step Trs, the selection step Ts and the evolution step Trt are 48 ms, 0.6 ms and 48 ms, respectively, at a temperature of 25° C. and that there are 1024 scanning lines.

TABLE 1

| Curve | Control Mode | Tss/Ts | Tsp/Ts | Length of Td |
|---|---|---|---|---|
| a | 1/5 Delay 1-1 | 1/5 | 1/10 | 1 unit |
| b | 1/5 Delay 1-3 | 1/5 | 1/10 | 3 units |
| c | 1/3 Delay 1-2 | 1/3 | 1/6 | 2 units |
| d | 1/3 Delay 1-3 | 1/3 | 1/6 | 3 units |
| e | 1/3 Delay 1-4 | 1/3 | 1/6 | 4 units |
| f | 1/1 Delay 1-1 | 1/1 | 1/2 | 1 unit |
| g | 1/1 Delay 1-2 | 1/1 | 1/2 | 2 units |
| h | 1/1 Delay 1-3 | 1/1 | 1/2 | 3 units |
| i | 1/1 Delay 1-4 | 1/1 | 1/2 | 4 units |
| j | Single Side Writing | | | |
| k | Double Side Writing | | | |

The liquid crystal display apparatus 10 has two display panels 11R and 11L, and different characteristic curves are used when only one of the panels is renewed (see curve j) and when both the panels are renewed (see curve k).

In switching characteristic curves, a characteristic curve is selected in consideration for the followings: in order to prevent an excess increase in peak current, the writing time should not be shortened excessively; and in order to permit full performance of the driving circuit, the pulse width of the selection pulse should not be narrowed excessively. Further, the lower limit of the writing time in the double writing mode is preferably longer than the lower limit of the writing time in the single writing mode, and it is usually desired that the former is more than double the latter. Furthermore, the writing time should not be unnecessarily long.

Specifically, in the single writing mode, the lower limit of the writing time is set to 200 ms, and the upper limit of the writing time is set to approximately 600 ms. Then, some characteristic curves are selected in accordance with temperature so that the writing time at any temperature will be within the range from 200 ms to approximately 600 ms. More specifically, as the curve j shows, in a low temperature range till 29° C., the characteristic curve a is adopted; in a temperature range over 29° C. to 38° C., the characteristic curve c is adopted; and in a high temperature range beyond 38° C., the characteristic curve f is adopted. Also, in changing characteristic curves, a characteristic curve which does not make the pulse width of the selection pulse too narrow should be selected. For example, in the single writing mode, it is possible to change from the characteristic curve a to the characteristic curve b at 29° C.; however, if so, the pulse width of the selection pulse becomes too narrow. In order to avoid this trouble, the characteristic curve c is selected.

On the other hand, in the double writing mode, the lower limit of the writing time is set to 600 ms, and the upper limit of the writing time is set to approximately 1200 ms. Then, some characteristic curves are selected in accordance with temperature so that the writing time at any temperature will be within the range from 600 ms to approximately 1200 ms. More specifically, as the curve k shows, in a low temperature range till 11° C., the characteristic curve a is adopted; in a temperature range over 11° C. to 22.5° C., the characteristic curve b is adopted; in a temperature range over 22.5° C. to 26° C., the characteristic curve c is adopted; in a temperature range over 26° C. to 32.5° C., the characteristic curve d is adopted; in a temperature range over 32.5° C. to 37° C., the characteristic curve e is adopted; in a temperature range over 37° C. to 39° C., the characteristic curve f is adopted; in a temperature range over 39° C. to 48° C., the characteristic curve g is adopted; in a temperature range over 48° C. to 58° C., the characteristic curve h is adopted; and in a temperature range beyond 58° C., the characteristic curve i is adopted.

Thus, the characteristic curves are combined in a different way between the single writing mode and the double writing mode. Accordingly, at least one of the following conditions (a), (b) and (c) changes in a different way between the single writing mode and the double writing mode: (a) the length of the delay step (in this example, the length of the whole cycle of driving pulses changes in accordance with circumstantial temperature, and precisely speaking, the rate of the length of the delay step to the length of the scanning step); (b) the ratio of the respective pulses in the cycle of driving pulses (in this example, Tsp/Ts or Tss/Ts); and (c) the length of the whole cycle of driving pulses with the ratio of the pulse widths of the respective pulses fixed.

Further, within a specified temperature range, while Tsp/Ts is constant, the length of the delay step (in this example, more precisely, the rate of the length of the delay step to the length of the scanning step) becomes larger as the circumstantial temperature is rising. Also, in a specified temperature range before the change to the next characteristic curve, while the ratio of the pulse widths of the respective pulses Tsp/Ts (or Tss/Ts) is constant, the length of the whole cycle of driving pulses is changed.

In this control, as the circumstantial temperature is rising, the length of the whole cycle of driving pulses is shortened, and in a temperature range in which Tsp/Ts (or Tss/Ts) is kept constant, as the circumstantial temperature is rising, the length of the delay step (in this example, the rate of the length of the delay step to the length of the scanning step) becomes larger. Also, the rate Tsp/Ts in a higher temperature range is larger than the rate Tsp/Ts in a lower temperature range. Information about which characteristic curve is to be adopted in each temperature range was stored in the ROM 55 beforehand, and a specified characteristic curve is selected in accordance with information received by the temperature sensors 31R and 31L.

With this control, even when writing is carried out on both the panels simultaneously, the peak current does not rise excessively, and breaks of parts and other trouble can be avoided.

### Writing Example; See FIGS. 17 through 19

Now, examples of writing on the display panels 11R and 11L are shown. FIG. 17 shows turning of pages in the double writing mode. Here, displays of page 3 and page 4 are changed to displays of page 5 and page 6. FIG. 18 shows turning of pages in the single writing mode, and here a display of page 3 on the right panel 11R is changed to a display of page 4. FIG. 19 shows a partial writing mode to write in a part of a display panel. Here, a menu for carrying out tone adjustment is shown.

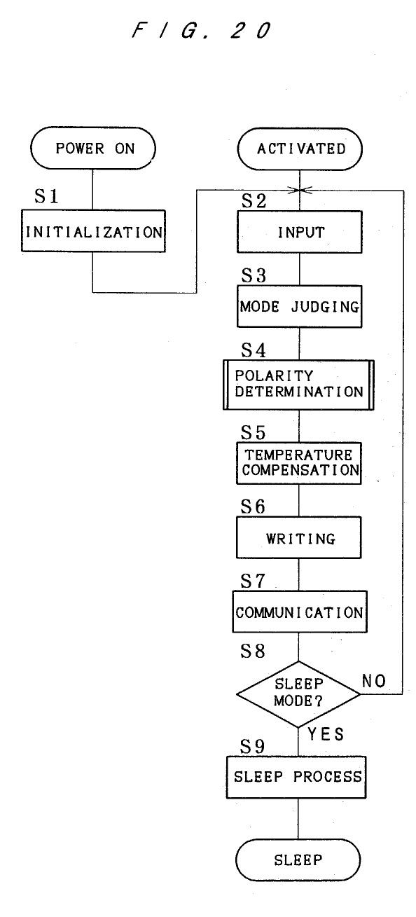

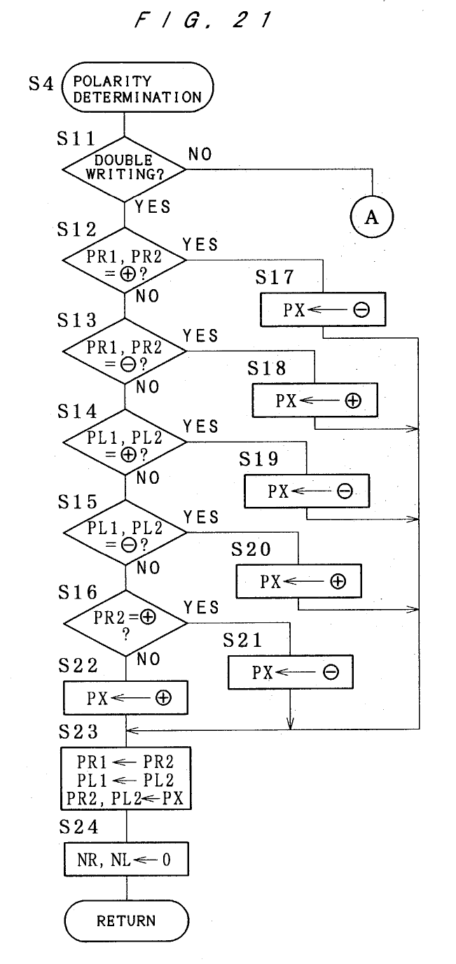

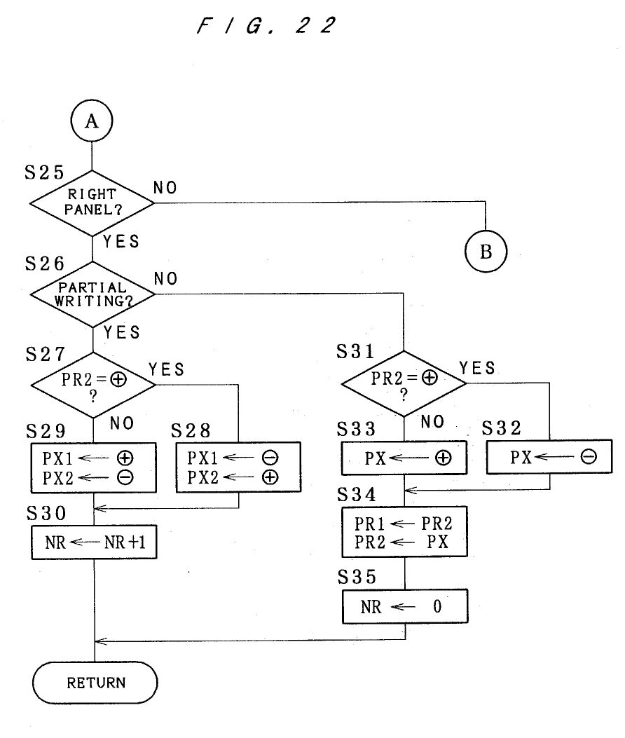

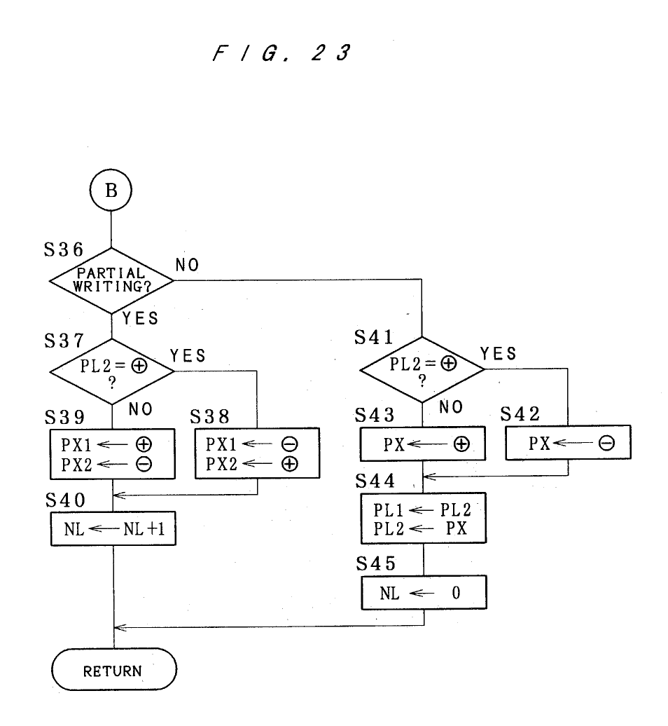

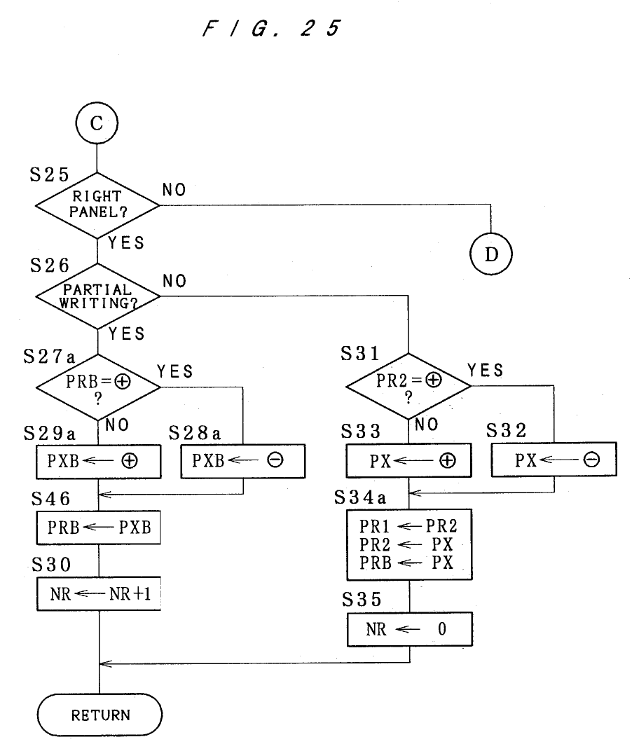

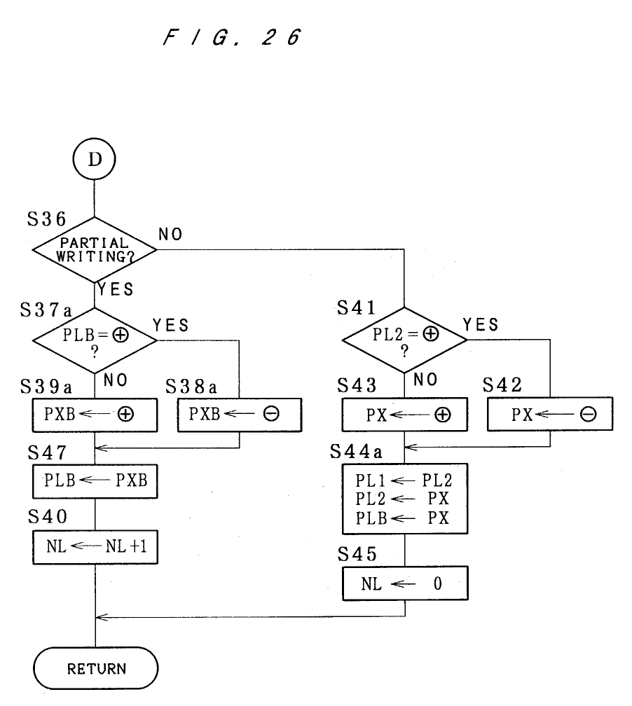

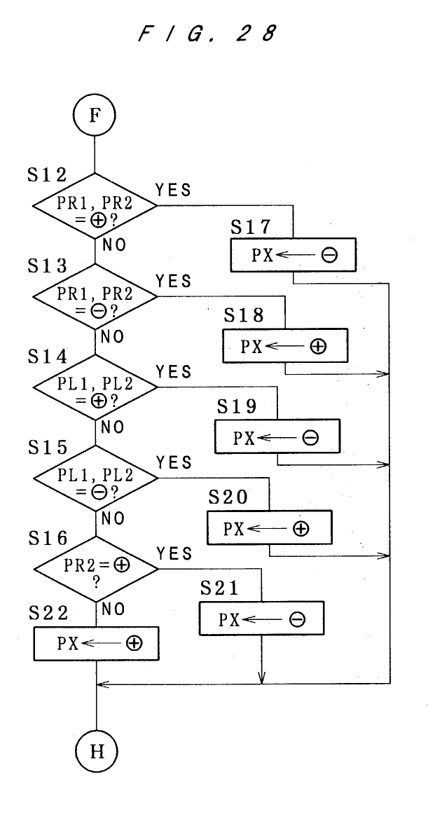

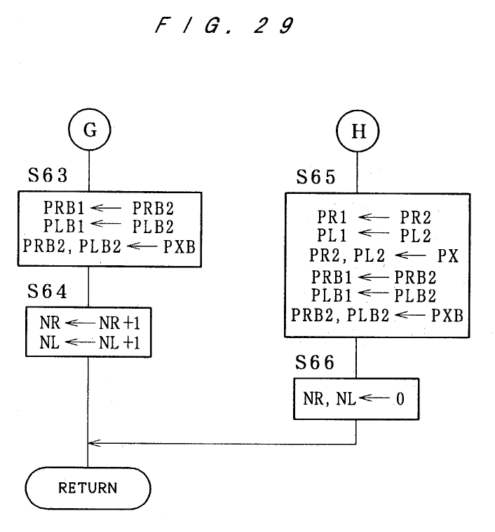

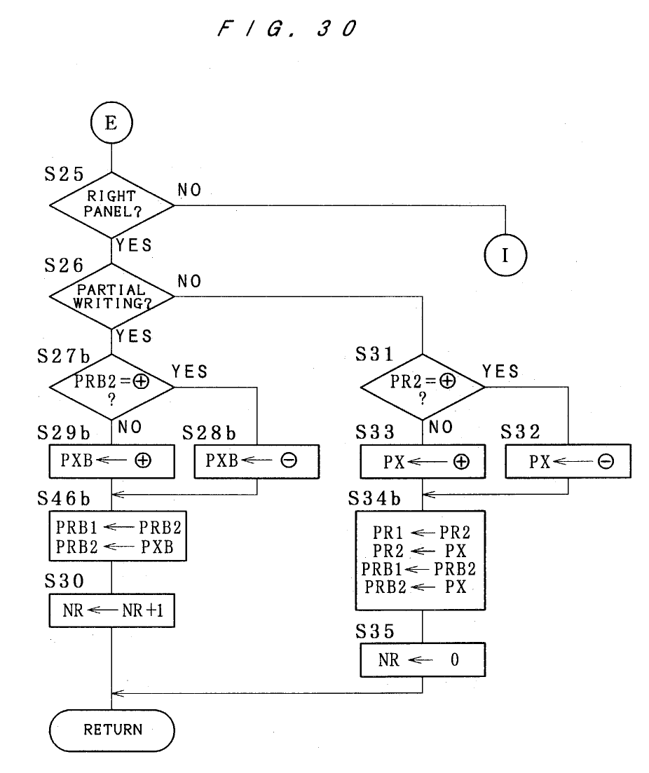

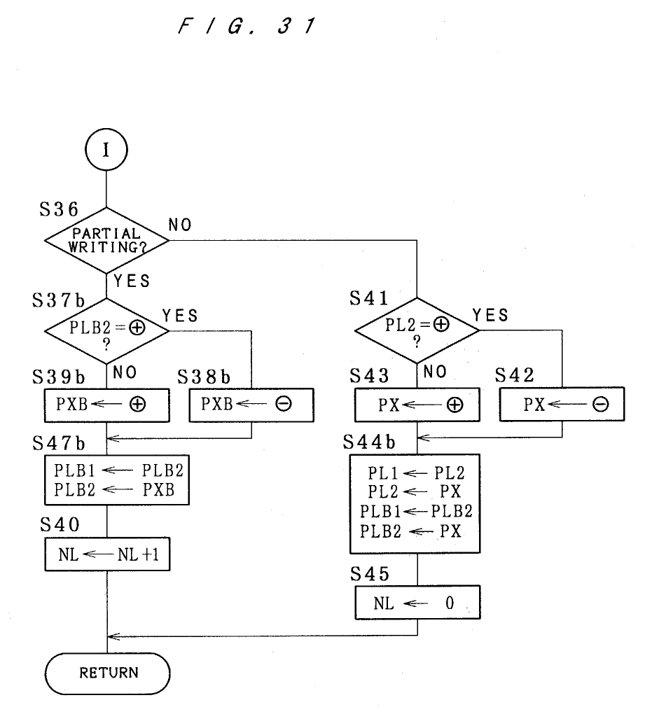

### Control Procedure; See FIGS. 20 through 31

In the following, a control procedure of the liquid crystal display apparatus 10 carried out by the CPU 51 is described.

FIG. 20 shows a main routine of the control procedure. When the power is turned on, at step S1, various devices and various parameters stored in the RAM 56 are initialized. Thereafter, at steps S2 through S9, various kinds of processing are carried out. When the apparatus 10 is activated from a sleep state, the routine starts at step S2.

The parameters will be described later; if the memory stored with these parameters is a nonvolatile memory, it is not necessary to initialize these parameters at step S1.

In an input process at step S2, the states of the operation panel and the touch panels are confirmed. In a mode judging process at step S3, the inputted operation mode (single writing mode, double writing mode, etc.) is judged. In a polarity determination process at step S4, the polarity of driving pulses to write an image is determined. A subroutine of this polarity determination process will be described later. In a temperature compensation process at step S5, driving pulses are adjusted in accordance with circumstantial temperature. In a writing process at step S6, a specified image is written on the liquid crystal display panel(s). In a communication process at step S7, communication with an external apparatus is carried out via a communication unit. In the polarity determination process at step S4, as will be described later, driving pulse polarity data determined at this step are stored in a memory as a plurality of parameters. Then, in the writing process at step S6, in accordance with the polarity indicated by the parameters, writing is carried out.

Thereafter, it is judged at step S8 whether the apparatus is to come to a sleep mode. If “YES” at step S8, a sleep process is carried out at step S9, and if “NO” at step S8, the routine returns to step S2.

FIGS. 21 through 23 show a first example of the polarity determination process carried out at step 4. The following parameters are used in this subroutine:

PR1 which indicates the polarity of driving pulses for the writing before the last on the right panel;

PR2 which indicates the polarity of driving pulses for the last writing on the right panel;

PL1 which indicates the polarity of driving pulses for the writing before the last on the left panel;

PL2 which indicates the polarity of driving pulses for the last writing on the left panel;

PX which indicates the polarity of driving pulses for the writing to be carried out now;

PX1 which indicates the polarity of driving pulses for the first writing in a partial writing mode;

PX2 which indicates the polarity of driving pulses for the second writing in a partial writing mode;

NR which indicates the number of times of partial writing on the right panel; and

NL which indicates the number of times of partial writing on the left panel.

In this first example, first, it is judged at step S11 whether the double writing mode has been selected. If the double writing mode has been selected, at steps S12 through S16, it is judged whether the parameters PR1 and PR2 are positive or negative. If PR1 and PR2 are both positive (“YES” at step S12), at step S17, the parameter PX, which indicates the polarity of driving pulses for the writing to be carried out now, is set to the negative side. If PR1 and PR2 are both negative (“YES” at step S13), at step S18, the parameter PX is set to the positive side. Also, if PL1 and PL2 are both positive (“YES” at step S14), at step S19, the parameter PX is set to the negative side. If PL1 and PL2 are negative (“YES” at step S15), at step S20, the parameter PX is set to the positive side.

If the parameters PR1, PR2, PL1 and PL2 do not meet any of the above conditions (“NO” at step S15), the parameter PR2, which indicates the polarity of driving pulses for the last writing, is checked at step S16. If PR2 is positive, at step S21, the parameter PX is set to the negative side, and if PR2 is negative, at step S22, the parameter PX is set to the positive side.

Next, at step S23, updates of the parameters PR1, PR2, PL1 and PL2 are carried out as follows: PR1 is updated to have the content of PR2; PL1 is updated to have the content of PL2; PR2 and PL2 are updated to have the content of PX. Subsequently, at step S24, the parameters NR and NL are reset to “0”. The parameters NR and NL are used to determine the time of carrying out entire writing on the respective panels. Specifically, in order to prevent thinning of the image density, which is caused by crosstalk, when the number of times of partial writing on each of the panels comes to a specified number, writing on the entire panel is carried out. The detailed description of the control is omitted.

When the single writing mode has been selected (“NO” at step S11), it is judged at step S25 which of the right panel and the left panel is to be subjected to writing. If the right panel is to be subjected to writing, it is judged at step S26 whether the partial writing mode has been selected. If “YES” at step S26, the parameter PR2 is checked at step S27. If PR2 is positive, at step S28, the parameter PX1 is set to the negative side, and the parameter PX2 is set to the positive side. On the other hand, if PR2 is negative, at step S29, the parameter PX1 is set to the positive side, and the parameter PX2 is set to the negative side. In the first example, in the partial writing mode, writing is carried out twice in the opposite polarities in the writing region. Next, at step S30, the parameter NR gains an increment.

In a case of carrying out writing only on the right panel entirely (“NO” at step S26), the parameter PR2 is checked at step S31. If PR2 is positive, the parameter PX is set to the negative side at step S32, and if PR2 is negative, the parameter PX is set to the positive side at S33. Next, at step S34, the parameter PR1 is updated to have the content of PR2, and the parameter PR2 is updated to have the content of PX. Further, the parameter NR is set to “0” at step S35.

On the other hand, when the left panel is to be subjected to writing (“NO” at step S25), it is judged at step S36 whether the partial writing mode has been selected. If the partial writing mode has been selected, the parameter PL2 is checked at step S37. If PL2 is positive, at step S38, the parameter PX1 is set to the negative side, and the parameter PX2 is set to the positive side. If PL2 is negative, at step S39, the parameter PX1 is set to the positive side, and the parameter PX2 is set to the negative side. These processes in the partial writing mode are to carry out writing on the left panel twice in the writing region. Next, the parameter NL gain an increment at step S40.

In a case of carrying out writing only on the left panel entirely (“NO” at step S36), the parameter PL2 is checked at step S41. If PL2 is positive, the parameter PX is set to the negative side at step S42, and if PL2 is negative, the parameter PX is set to the positive side at step S43. Next, at step S44, the parameter PL1 is updated to have the content of PL2, and the parameter PL2 is updated to have the content of PX. Further, the parameter NL is reset to “0” at step S45.

By updating the parameters following the flowchart, although writing is carried out repeatedly in the double writing mode and in the single writing mode, in the writing process at step S6 of the main routine, it is prevented that writing in the same polarity is carried out continuously three times or more. Also, in the partial writing mode, writing is carried out twice in the opposite polarities, and thereby, although writing is carried out repeatedly in the entire writing mode and in the partial writing mode, it is prevented that writing in the same polarity is carried out continuously three times or more.

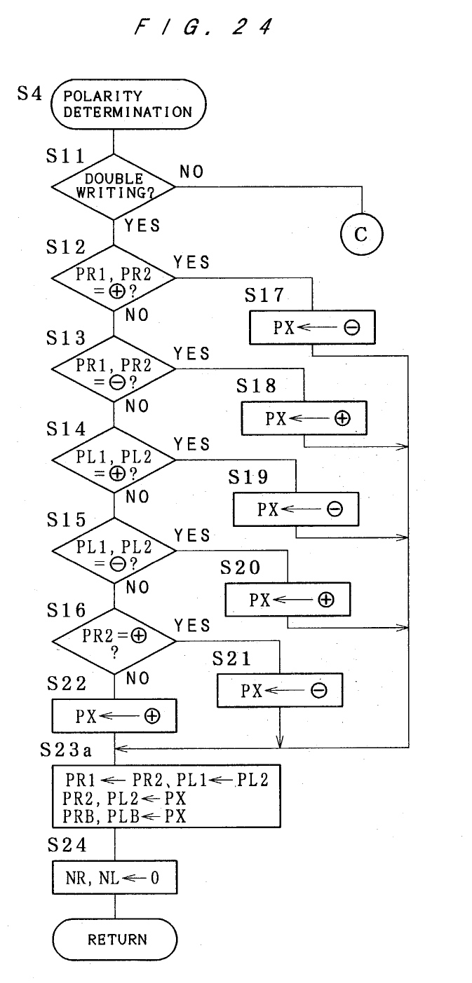

FIGS. 24 through 26 show a second example of the polarity determination process which is carried out at step S4. In this subroutine, the following parameters are additionally used:

PRB which indicates the polarity of driving pulses for the last partial writing on the right panel;

PLB which indicates the polarity of driving pulses for the last partial writing on the left panel; and

PXB which indicates the polarity of driving pulses for the partial writing to be carried out now.

In the second example, the polarity of driving pulses for partial writing on the right panel and the polarity of driving pulses for partial writing on the left panel are stored in a memory so that the writing region can be prevented from being subjected to writing in the same polarity continuously.

At steps S11 through S22 and S24 of this second example, the same processes at steps S11 through S22 and S24 in the first example are carried out. At step S23 a of the second example, in addition to the process carried out at step S23, the parameters PRB and PLB are updated to have the content of the parameter PX.

When the single writing mode has been selected (“NO” at step S11), if the right panel is to be subjected to writing (“YES” at step S25) and if the partial writing mode has been selected (“YES” at step S26), the parameter PRB is checked at step S27a. If PRB is positive, the parameter PXB is set to the negative side at step S28a. On the other hand, if PRB is negative, the parameter PXB is set to the positive side at step S29a. Then, the parameter PRB is updated to have the content of the parameter PXB at step S46. In the second example, by additionally using the parameters PRB, PLB and PXB, the writing region is prevented from being subjected to writing in the same polarity continuously. Next, the parameter NR1 gains an increment at step S30.

In a case of carrying out writing only on the right panel entirely (“NO” at step S26), the same processes in the first example are carried out at steps S31, S32, S33 and S35. However, at step S34a, additionally, the parameter PRB is updated to have the content of the parameter PX.

When only the left panel is to be subjected to writing (“NO” at step S25), if the partial writing mode has been selected (“YES” at step S36), the parameter PLB is checked at step S37a. If PLB is positive, the parameter PXB is set to the negative side at step S39a. If PLB is negative, the parameter PXB is set to the positive side at step S39a. Then, the parameter PLB is updated to have the content of the parameter PXB at step S47. These processes are to prevent the writing region from being subjected to writing in the same polarity continuously. Next, the parameter NL gains an increment at step S40.

In a case of carrying out writing only on the left panel entirely (“NO” at step S36), the same processes in the first example are carried out at steps S41, S42, S43 and S45. However, at step S44a, additionally, the parameter PLB is updated to have the content of the parameter PX.

In the second example, by storing the polarity of driving pulses for partial writing in a memory, it becomes possible to prevent the writing region from being subjected to writing in the same polarity continuously. Thus, in the partial writing mode, it is no longer necessary to carry out writing a plurality of times, and partial writing is easier.

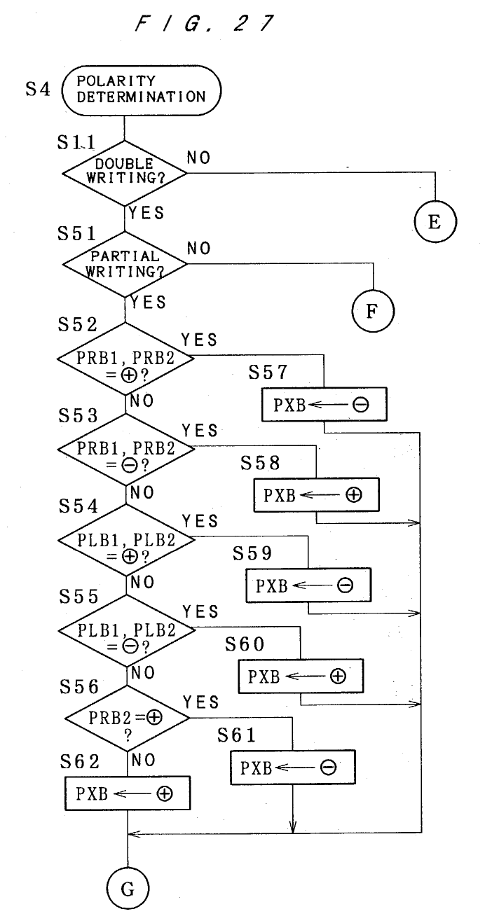

FIGS. 27 through 31 show a third example of the polarity determination process which is carried out at step S4. In this subroutine, the following parameters are further used:

PRB1 which indicates the polarity of driving pulses for the partial writing before the last partial writing on the right panel;

PRB2 which indicates the polarity of driving pulses for the last partial writing on the right panel;

PLB1 which indicates the polarity of driving pulses for the partial writing before the last partial writing on the left panel; and

PLB2 which indicates the polarity of driving pulses for the last partial writing on the left panel.

In this third example, in consideration for also a case of carrying out partial writing simultaneously on the right panel and on the left panel, the polarity of driving pulses is determined. In carrying out partial writing on the right panel and on the left panel simultaneously, the polarity of driving pulses is determined so that not more than three times of writing in the same polarity will not continue.

In the third example, first, it is judged at step S11 whether the double writing mode has been selected. When the double writing mode has been selected, it is judged at step S51 whether the partial writing mode has been selected. When the partial writing mode has been selected, the parameters PRB1 and PRB2 are checked at steps S52 through S56. If PTB1 and PTB2 are both positive (“YES” at step S52), the parameter PXB, which indicates the polarity of driving pulses for the writing to be started now, is set to the negative side. If PRB1 and PRB2 are both negative (“YES” at step S53), the parameter PXB is set to the positive side. If PLB1 and PLB2 are both positive (“YES” at step S54), the parameter PXB is set to the negative side at step S59. If PLB1 and PLB2 are both negative (“YES” at step S55), the parameter PXB is set to the positive side at step S60.

If the parameters PRB1, PRB2, PLB1 and PLB2 do not meet any of the above conditions (“NO” at step S55), the parameter PRB2, which indicates the polarity of driving pulses for the last writing on the right panel, is checked at step S56. If PRB2 is positive, the parameter PXB is set to the negative side at step S61, and if PRB2 is negative, the parameter PXB is set to the positive side at step S62.

Next, at step S63, updates of the parameters are carried out as follows: PRB1 is updated to have the content of PRB2; PLB1 is updated to have the content of PLB2; and PRB2 and PLB2 are updated to have the content of PXB. Then, at step S64, the parameters NR and NL each gain an increment.

In a case of carrying out writing on both the panels entirely (“NO” at step S51), the processes at step S12 through S22 are carried out. These are the same processes at steps S12 through S22 in the first example. After these processes, at step S65, updates of the parameters are carried out as follows: PR1 is updated to have the content of PR2; PL1 is updated to have the content of PL2; PR2; PL2 are updated to have the content of PX; PRB1 is updated to have the content of PRB2; PLB1 is updated to have the content of PLB2; and PRB2 and PLB2 are updated to have the content of PXB. Then, the parameters NR and NL are reset to “0” at step S66.

In a case of carrying out writing on only the right panel partially (“NO” at step S11, “YES” at step S25 and “YES” at step S26), the parameter PRB2 is checked at step S27b. If PRB2 is positive, the parameter PXB is set to the negative side at step S28b. If PRB2 is negative, the parameter PXB is set to the positive side at step S29b. Then, at step S46b, the parameter PRB1 is updated to have the content of the parameter PRB2, and the parameter PRB2 is updated to have the content of the parameter PXB. Next, the parameter NR gains an increment at step S30.

In a case of carrying out writing on only the right panel entirely (“NO” at step S26), the processes at steps S31, S32, S33 and S35 are carried out as in the first example. However, at step S34b, additionally, the parameter PRB1 is updated to have the content of the parameter PRB2, and the parameter PRB2 is updated to have the content of the parameter PX.

On the other hand, in a case of carrying out writing only on the left panel partially (“NO” at step S25 and “YES” at step S36), the parameter PLB2 is checked at step S37b. If PLB2 is positive, the parameter PXB is set to the negative side at step S38b. If PLB2 is negative, the parameter PXB is set to the positive side at step S39b. Then, at step S47b, the parameter PLB1 is updated to have the content of the parameter PLB2, and the parameter PLB2 is updated to have the content of the parameter PXB, Next, the parameter NL gains an increment at step S40.

In a case of carrying out writing on only the left panel entirely (“NO” at step S36), the processes at steps S41, S42, S43 and S45 are carried out as in the first example. However, at step S44b, additionally, the parameter PLB1 is updated to have the content of the parameter PLB2, and the parameter PLB2 is updated to have the content of the parameter PXB.

### Other Embodiments

FIG. 2 shows a structure of the liquid crystal displays; however, the liquid crystal displays may be of any other structure and may be made of any materials by any methods. Also, as well as the procedures shown by FIGS. 20 through 31, other procedures may be possible. Each of the liquid crystal displays may have only a single layer, may have two layers, or may have four or more layers.

The characteristic curves j and k for the single writing mode and for the double writing mode shown by FIG. 16 are merely examples. Also, it is not necessary to change Tss/Ts step by step at the borders among temperature ranges, and Tss/Ts may be changed gradually within the whole operative temperature range.

In the above embodiment, a liquid crystal display apparatus with two screens have been described; however, the present invention is applicable to a liquid crystal display apparatus with three or more screens. In a liquid crystal display apparatus with three or more screens, with respect to each of the panels, the polarities of driving pulses for the last several times of writing should be stored, and the polarity of driving pulses for the current writing should be determined based on the stored data. In such a liquid crystal display apparatus with three or more screens, however, there are cases of carrying out writing on a plural number of panels simultaneously, the number being smaller than the total number of panels, and the respective panels are more likely to vary in polarity history compared with a liquid crystal display apparatus with two screens. Therefore, preferably, as well as the polarity in the last writing and the polarity in the writing before last, the polarities in the farther previous times of writing are stored. For partial writing, a similar control procedure to the control of the liquid crystal display with two screens is possible.

Although the present invention has been described in connection with the preferred embodiment above, it is to be noted that various changes and modifications are possible to those who are skilled in the art. Such changes and modifications are to be understood as being within the scope of the present invention.

What is claimed is:

1. A liquid crystal display apparatus comprising:
a first display panel and a second display panel which use liquid crystal as display media;
a driving circuit which drives the first display panel and the second display panel by a cycle of driving pulses;
a controller for controlling the driving circuit; and
a temperature sensor for detecting circumstantial temperatures of the first display panel and the second display panel;
wherein:
each of the first and second display panels has a screen composed of a plurality of pixels arranged in a matrix;
the driving circuit scans the pixels of each of the first and second display panels in such a way that pixels on one line are scanned at a time;
the controller is selectable between a single writing mode where the driving circuit drives either one of the first and second display panels and a double writing mode where the driving circuit drives both the first and second display panels simultaneously;
the controller changes at least one of the following conditions in accordance with circumstantial temperature: (a) a rate of a length of a delay step inserted between sequentially scanned scanning lines to a length of a scanning step; (b) a ratio of pulse widths of the driving pulses in a cycle; and (c) a length of the whole cycle of driving pulses with the ratio of pulse widths of the driving pulses in a cycle kept constant, and changes at least one of the conditions (a), (b) and (c) in a different way between the single writing mode and the double writing mode.

2. A liquid crystal display apparatus according to claim 1, wherein:
the first and second display panels make displays by using selective reflection of a cholesteric liquid crystal phase;
the driving circuit applies driving pulses to the liquid crystal in a duration comprising a reset step of applying a reset pulse to reset the liquid crystal to a homeotropic state, a selection step of applying a selection step to select a desired final state of the liquid crystal and an evolution step of applying an evolution pulse to cause the liquid crystal to evolve to the selected state; and
the controller, as long as circumstantial temperature changes within a first range, changes the conditions (a) and (c) in accordance with the circumstantial temperature while keeping the condition (b) constant, as long as the circumstantial temperature changes within a second range which is different from the first range, changes the conditions (a) and (c) in accordance with the circumstantial temperature while keeping the condition (b) constant by fixing a rate Tsp/Ts to a value which is different from that in the first temperature range, in which Tsp is a length of a selection pulse application step which is a step of applying a selection pulse to each pixel on a scanning line, and Ts is a length of the selection step between an end of application of the reset pulse and a start of application of the evolution pulse.

3. A liquid crystal display apparatus according to claim 2, wherein the controller, as long as circumstantial temperature changes within a third temperature range which is narrower than and included in the first temperature range, changes the condition (c) in accordance with the circumstantial temperature, while keeping the conditions (a) and (b).

4. A liquid crystal display apparatus according to claim 1, wherein the controller changes at least one of the conditions (a), (b) and (c) in accordance with circumstantial temperature in the double writing mode and in the single writing mode in such a way that a lower limit of a writing time in the double writing mode is larger than twice a lower limit of a writing time in the single writing mode.

5. A liquid crystal display apparatus according to claim 1, wherein:
the first and second display panels make displays by using selective reflection of a cholesteric liquid crystal phase;
the driving circuit applies driving pulses to the liquid crystal in a duration comprising a reset step of applying a reset pulse to reset the liquid crystal to a homeotropic state, a selection step of applying a selection step to select a desired final state of the liquid crystal and an evolution step of applying an evolution pulse to cause the liquid crystal to evolve to the selected state; and
the controller changes the condition (b) and/or the condition (c) in accordance with circumstantial temperature in such a way that the selection pulse has a pulse width not less than a specified width.

6. A liquid crystal display apparatus according to claim 1, wherein:
the first and second display panels make displays by using selective reflection of a cholesteric liquid crystal phase;
the driving circuit applies driving pulses to the liquid crystal in a duration comprising a reset step of applying a reset pulse to reset the liquid crystal to a homeotropic state, a selection step of applying a selection step to select a desired final state of the liquid crystal and an evolution step of applying an evolution pulse to cause the liquid crystal to evolve to the selected state; and
the controller changes the condition (b) in accordance with circumstantial temperature by changing a rate Tsp/Ts to a value which is different from that in the first temperature range, in which Tsp is a length of a selection pulse application step which is a step of applying a selection pulse to each pixel on a scanning line, and Ts is a length of the selection step between an end of application of the reset pulse and a start of application of the evolution pulse, the changes in Tsp/Ts in the single writing mode and the changes in Tsp/Ts in the double writing mode being different from each other.

7. A liquid crystal display apparatus comprising:
a first display panel and a second display panel which use liquid crystal as display media; and
a driving circuit for driving the first and second display panels;
wherein:
the driving circuit applies a cycle of driving pulses composed of a plural kinds of pulses to the liquid crystal of the first and second display panels; and
a voltage of at least one kind of pulse of the plural kinds is supplied to the first and second display panels respectively via mutually independent power source terminals and voltages of the other kinds of pulses are supplied to the first and second display panels via common power source terminals.

8. A liquid crystal display apparatus according to claim 7, wherein:
each of the first and second display panels has a liquid crystal layer between a plurality of scanning electrodes and a plurality of signal electrodes;
the scanning electrodes are connected to a scanning electrode driving IC and the signal electrodes are connected to a signal electrode driving IC;
a cycle of scanning electrode driving pulses composed of a plural kinds of pulses is applied to each of the scanning electrodes from the scanning electrode driving IC; and
a voltage of at least one kind of pulse of the plural kinds is supplied to the first and second display panels respectively via mutually independent power source terminals and voltages of the other kinds of pulses are supplied to the first and second display panels via common power source terminals.

9. A liquid crystal display apparatus according to claim 8, wherein the scanning electrode driving IC comprises a power switching circuit for switching power source terminals to supply voltages and a level shifter for carrying out voltage compensation at a time of switching power source terminals, and the scanning electrode driving IC inverts a polarity of the driving pulses applied to the scanning electrodes.

10. A liquid crystal display apparatus according to claim 7, wherein:
at least one of the first and second display panels is a laminate type liquid crystal display panel which comprises a plurality of liquid crystal layers stacked one upon another;
each of the liquid crystal layers of the laminate type liquid crystal display panel has a liquid crystal layer between a plurality of scanning electrodes and a plurality of signal electrodes; and
one scanning electrode driving IC is used to apply voltages to the scanning electrodes of the respective liquid crystal layers of the laminate type liquid crystal display panel.

11. A liquid crystal display apparatus according to claim 7, wherein;
the first and second display panels make displays by using selective reflection of a cholesteric liquid crystal phase; and
the driving circuit applies driving pulses to the liquid crystal in a duration comprising a reset step of applying a reset pulse to reset the liquid crystal to a homeotropic state, a selection step of applying a selection step to select a desired final state of the liquid crystal and an evolution step of applying an evolution pulse to cause the liquid crystal to evolve to the selected state.

12. A liquid crystal display apparatus according to claim 11, wherein a voltage of the selection pulse is supplied to the first and second display panels respectively via mutually independent power source terminals.

13. A liquid crystal display apparatus according to claim 11, wherein a voltage of the reset pulse and a voltage of the evolution pulse are supplied to the first and second display panels via common power source terminals.

14. A liquid crystal display apparatus comprising:
a display section which comprises at least one liquid crystal panel which is capable of continuously displaying an image with application of no voltages thereto;
a driving circuit for driving the display section; and
a controller for controlling the driving circuit;
wherein:
the controller sends the driving circuit a command of writing on part of the display section and a command of writing on the entire display section;
in carrying out writing, the controller controls the driving circuit to carry out writing of one frame by using driving pulses of one polarity, to carry out writing of a next frame by using driving pulses of an opposite polarity and to select the polarity of driving pulses so that an area of the display section will not be subjected continuously to a specified number of or more times of writing in the same polarity.

15. A liquid crystal display apparatus according to claim 14, wherein:
the controller sends the driving circuit a command of writing on part of the liquid crystal panel and a command of writing on the entire liquid crystal panel;
in carrying out writing, the controller controls the driving circuit to carry out writing of one frame by using driving pulses of one polarity, to carry out writing of a next frame by using driving pulses of an opposite polarity and to select the polarity of driving pulses so that an area of the liquid crystal panel will not be subjected continuously to a specified number of or more times of writing in the same polarity.

16. A liquid crystal display apparatus according to claim 14, wherein:
the display section comprises a plurality of liquid crystal panels;
the controller sends a command of writing on a first number of liquid crystal panels and a command of writing on a second number of liquid crystal panels, in which the first number is smaller than the total number of liquid crystal panels and the second number is larger than the first number;
in carrying out writing on the first number or the second number of liquid crystal panels, the controller controls the driving circuit to carry out writing of one frame by using driving pulses of one polarity, to carry out writing of a next frame by using driving pulses of an opposite polarity and to select the polarity of driving pulses so that each of the liquid crystal display panels will not be subjected continuously to a specified number of or more times of writing in the same polarity.

17. A liquid crystal display apparatus according to claim 14, further comprising a memory for storing the polarity of driving pulses,
wherein the controller determines the polarity of driving pulses with reference to data stored in the memory.

18. A liquid crystal display apparatus according to claim 14, wherein in carrying out writing, the controller determines the polarity of driving pulses so that an area of the display section will not be subjected continuously to two or more times of writing in the same polarity.

19. A liquid crystal display apparatus according to claim 14, wherein in carrying out writing on part of the display section, the controller controls the driving circuit to carry out a plurality of times of writing while using driving pulses of one polarity and using driving pulses of an opposite polarity alternately.

20. A liquid crystal display apparatus according to claim 14, wherein:
the liquid crystal panel has a liquid crystal layer between a plurality of scanning electrodes and a plurality of signal electrodes; and
the driving circuits applies driving pulses of substantially one polarity to the scanning electrodes and applies specified driving pulses to the signal electrodes in synchronization with the driving pulses applied to each of the scanning electrodes.
